(19) United States
(12) Patent Application Publication
(10) Pub. No.: US 2008/0233507 A1
(43) Pub. Date: Sep. 25, 2008

(54) TWO COMPONENT DEVELOPER

(75) Inventors: Hiroshi Yamazaki, Tokyo (JP); Mikio Kouyama, Tokyo (JP); Ken Ohmura, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/013,158

(22) Filed: Jan. 11, 2008

(30) Foreign Application Priority Data
Mar. 19, 2007 (JP) 2007070303

(51) Int. Cl. G03G 9/087

(52) U.S. Cl. 430/109.3

(57) ABSTRACT

A two component developer used in an electrophotographic method composed of a toner containing at least a resin and a colorant, and a carrier, is disclosed. The resin is composed of a polyester resin and a styrene-acryl resin, in which the polyester resin is prepared via condensation-polymerization of a polyvalent carboxylic acid and a polyol in a state where a styrene monomer and an acrylate monomer exist in an aqueous medium containing an acidic compound, followed by formation of the styrene-acryl resin via radical polymerization of the styrene monomer and the acrylate monomer; and the carrier comprises magnetic material powder dispersed in a binder resin, and has a volume based median diameter of 10 μm-100 μm, a shape factor SF-1 of 1.0-1.2, and a shape factor SF-2 of 1.1-2.5.

This application is based on Japanese Patent Application No. 2007-70303 filed on Mar. 19, 2007, in Japanese Patent Office, the entire content of which is hereby incorporated by reference.

### TECHNICAL FIELD

The present invention relates to a two component developer composed of a toner and a carrier used for image formation via an electrophotographic method.

### BACKGROUND

In the technology field of image formation via an electrophotographic method, with the development of digital technology, it has been demanded to form a high quality image capable of precisely reproducing minute-dot images and highly detailed images. As one of the approaches thereto, there has been investigated to reduce the diameter of a toner. Further, a toner, referred, to as a so-called polymerized toner, has received recent attention, which is capable of controlling the shape and the size of particles in the toner production process.

This polymerized toner is composed of toner particles prepared by aggregating particles of the toner constituent components such as resin particles, colorant particles, and, if appropriate, other particles via a polymerization process employing a polymerization method such as an emulsion polymerization method.

As one of the resin particles constituting the polymerized toner, a styrene-acryl resin particle may be cited as an example. This particle is formed via the emulsion polymerization method as follows: oil droplets are formed by dispersing a polymerizable monomer, serving as a raw material, in an aqueous medium containing an emulsifier, followed by addition of a polymerization initiator to carry out radical polymerization in the oil droplets (refer, for example, to Patent Documents 1 and 1).

Recently, energy conservation for imaging apparatuses has been investigated from the viewpoint of concern for the global environment, and specifically, a decrease of energy required to fix a toner image has received much attention. Thus, there has been in demand a so-called low-temperature fixable toner enabling a toner image to be melted and fixed at lower temperatures than conventional toners. A toner employing the styrene-acryl resin has an amorphous structure and exhibits performance of lowering of the softening point, whereby its applications to image formation responding to the low-temperature fixing have been anticipated.

However, although the toner employing the styrene-acryl resin exhibits excellent low-temperature fixability, there has been a continuing problem that an image formed with the toner tends to easily peel off and be damaged and the fixing strength of a fixed toner image tends not to be stably realized, due to forces such as creasing, bending, or rubbing applied to the fixed toner image formed on a transfer medium. Therefore, one approach has been directed to enhance the fixing strength via formation of a resin featuring a cross-linked structure, which, however, resulted in no adequate effect.

In contract, there exist toners employing a polyester resin. Such toners employing a polyester resin exhibit a high softening point compared with those employing a vinyl resin, but there are advantages that the toner melts within a narrow temperature range and a strong and stable image can be realized with no peeling even via application of forces such as creasing or bending to the fixed toner image.

In view of such a background, much research effort has been directed toward the development of a toner featuring the merits of both the styrene-acryl resin and the polyester resin. For example, there has been investigated a production technology of a toner containing a styrene-acryl resin and a polyester resin via a kneading and a pulverizing process. In this method, an attempt to produce a toner featuring a hybrid structure formed by mixing a styrene-acryl resin and a polyester resin was carried out, wherein both of the resins were mixed, followed by pulverization after being treated at a melting and a kneading process (refer, for example, to Patent Document 3). Namely, there was carried out an attempt to enable simultaneous realization of a toner featuring both properties, that is, low-temperature fixability and fixed image strength attributed to the styrene-acryl resin and the polyester resin, respectively.

(Patent Document 1) Japanese Patent Publication Open to Public Inspection (hereinafter referred to as JP-A) 2000-214629

(Patent Document 2) JP-A 2001-125313

(Patent Document 3) JP-A H06-003856

However, when an image was formed using a pulverized toner prepared via a mixture of the polyester resin and the styrene-acryl resin, occurrence of image defects over long time use was surfaced. In the pulverized toner prepared via a mixture of the polyester resin and the styrene-acryl resin, since the difference in polarity between these resins tends not to allow compatibility, no uniformly dispersed structure is formed using a polyester resin and a styrene-acryl resin, resulting in formation of a phase-separated structure. It has been conceivable that in a toner forming the phase-separated structure, a state, where both a soft resin phase and a hard resin phase coexist, is generated, whereby the soft resin portion exhibiting weak mechanical strength peels off when the carrier and the toner contact each other during image formation, and then the soft resin portion, having peeled off, adheres to the carrier, resulting in occurrence of image contamination.

### SUMMARY OF THE INVENTION

An object of the present invention is to provide a new and useful two component developer in view of the foregoing. Specifically, the object includes to provide a two component developer which exhibits no or less image defects due to carrier contamination in a two component developer employing a toner containing a polyester resin and a styrene-acryl resin, and specifically to provide the two component developer capable of forming excellent prints with no image defects, even when printing a large number of sheets.

The problems have been overcome via the following constitutions.

The two component developer of this invention comprises a toner containing at least a resin and a colorant, and a carrier, wherein the resin is composed of a polyester resin and a styrene-acryl resin, in which the polyester resin is prepared via condensation-polymerization of a polyvalent carboxylic acid and a polyol in a state where a styrene monomer and an acrylate monomer exist in an aqueous medium containing an acidic compound, followed by formation of the styrene-acryl resin via radical polymerization of the styrene monomer and the acrylate monomer; and the carrier comprises magnetic material powder dispersed in a carrier binder resin and has a volume based median diameter of 10 μm-100 μm, a shape factor SF-1 of 1.0-1.2, and a shape factor SF-2 of 1.1-2.5.

The carrier is preferably prepared by dispersing magnetic material powder in a binder resin containing a phenol-formaldehyde resin formed via polymerization.

### BRIEF DESCRIPTION OF THE DRAWINGS

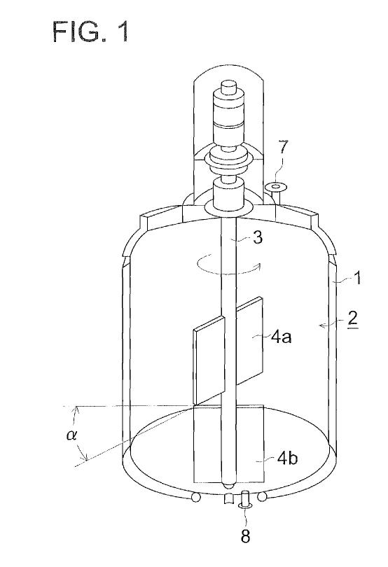

(FIG. 1) A perspective view showing one example of a reaction apparatus to prepare a toner.

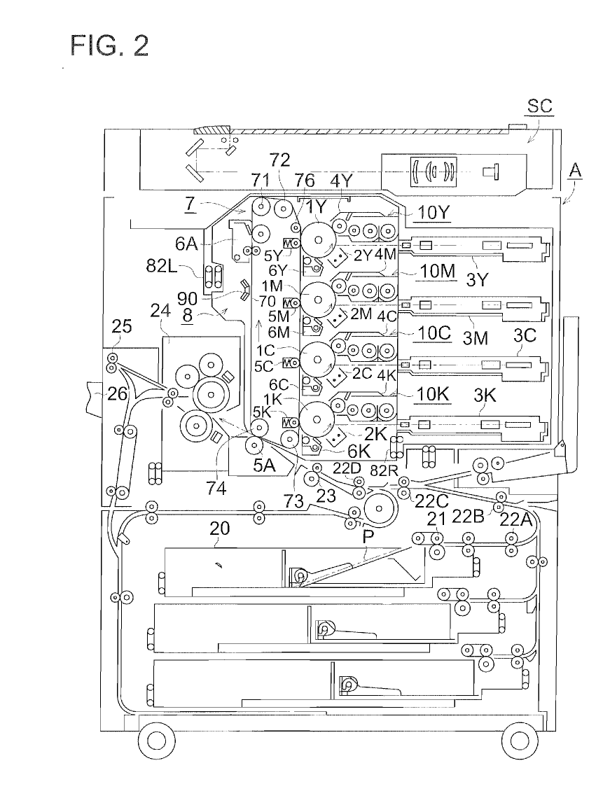

(FIG. 2) A cross-sectional configuration view showing one example of an image forming apparatus capable of using the two component developer of the present invention.

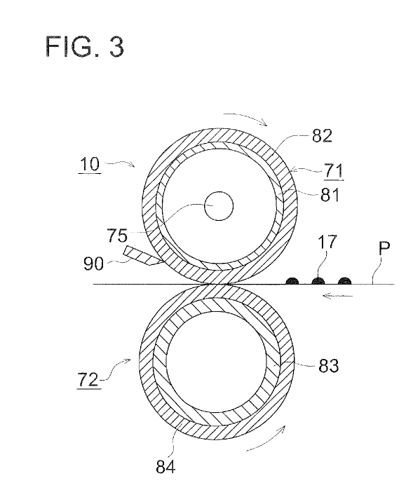

(FIG. 3) A schematic view showing one example of a fixing device employing a heating roller.

### BEST MODE TO CARRY OUT THE INVENTION

The present invention will now be described in further detail.

According to the present invention, it was found that a two component developer exhibiting no or less image defects due to carrier contamination was obtained via a toner containing composite resin particles in which a polyester resin and a styrene-acryl resin exist uniformly, as well as a specific resin dispersion-type carrier. Namely, as clearly shown in examples to be described later, an excellent, stable toner image featuring no or less electric charge amount variations, a predetermined image density, and no or less fogging have been realized even when printing a large number of sheets.

Further, via a toner containing composite resin particles of a Polyester resin and a styrene-acryl resin, the performance exhibited by the polyester resin and the styrene-acryl resin on their own was thoroughly exhibited, whereby high-temperature offsetting was decreased.

Further, the composite resin particle constituting the toner was made to feature a small diameter and negligible variation among the particles when prepared via a specific polymerization process, whereby a toner capable of precisely reproducing minute-dot images and fine-line images has been realized. Accordingly, a two component developer capable of stabilizing a high quality image responding to digital image formation over a long duration has been produced.

Still further, according to the present invention, carrier contamination due to adhesion of toner components has been prevented via the use of a specific resin dispersion-type carriers resulting in maintaining stable chargeability over a long duration.

The present invention relates to a two component developer containing a toner containing a polyester resin and a styrene-acryl resin as well as a carrier specified by its shape and size.

The present inventors found that long-term image formation caused no image defects via a two component developer employing a toner containing a composite resin particle, in which a polyester resin and a styrene-acryl resin existed uniformly, and a specific resin dispersion-type carrier serving as the carrier.

According to the present invention, it is assumed that via formation of the composite resin particle employing a polyester resin and a styrene-acryl resin, a highly dense dispersion state was formed with no phase separation between the polyester resin and the styrene-acryl resin in the toner, whereby a state, where the characteristics of both resins were exhibited, was realized. Namely, low-temperature melting properties possessed by the polyester resin was exhibited, whereby adhesion of the toner to an image forming support such as paper was realized at low temperatures. Further, high temperature elasticity possessed by the styrene-acryl resin was exhibited, whereby high-temperature offsetting was decreased.

Further, since this composite resin particle was prepared via a specific polymerization process, a toner, featuring a small particle diameter and negligible inter-particle variation, as well as narrow charge amount distribution, has been realized, resulting in precise reproduction of a minute-dot image and a fine line image. Therefore, it has been possible to stably carry out the formation of a high quality image responding to digital image formation for a long duration.

Still further, by use of a resin dispersion-type carrier, serving as the carrier, featuring a relatively spherical shape, durability has been further enhanced. The reason why the further enhancement of durability was realized is not clearly understood, but it is assumed that the realization is probably attributed to the following reason. Namely, since the toner of the present invention has a fine dispersion state, as described above, components melted at low temperatures are also present in a dispersion state, whereby a structure, in which a soft component featuring weak mechanical strength tends not to peel off, is formed. Further, low specific gravity properties exhibited by the resin dispersion-type carrier form a state where stress due to contact of the carrier and the toner is also decreased.

Accordingly, it is assumed that even when friction heat is slightly generated due to shear force created during stirring in a developing device, low-temperature melting components in the toner tend not to melt, whereby migration of soft components of the toner to the carrier is inhibited. Therefore, it is assumed that even in cases of repeated image formation over a long duration, no toner components adhere to the carrier surface, whereby stable chargeability is maintained for a long duration.

Based on the reasons described above, it is assumed that the effect of the present invention was produced via the two component developer according to the present invention.

The two component developer of the present invention is detailed below.

Initially, a toner constituting the two component developer of the present invention will now be described.

The present invention made it possible that a composite resin was prepared featuring a state where a polyester resin and a styrene-acryl resin were dispersed minutely and uniformly via the following steps employed for the toner-forming resins. Namely, in oil droplets containing a vinyl-based polymerizable monomer such as styrene or an acrylate, a polyester resin is formed via condensation-polymerization of a polyvalent carboxylic acid and a polyol. Then, after the formation of the polyester resin, a styrene-acryl resin is formed via radical polymerization of a vinyl-based polymerizable monomer. These steps made it possible to realize a composite resin particle containing a polyester resin and a styrene-acryl resin.

In the present invention, the term a “composite resin particle”, containing a polyester resin and a styrene-acryl resin, is used, wherein the “composite resin particle” refers to a resin, featuring a state where a polyester resin and a vinyl resin coexist, prepared via the following production process: namely, (1) a reaction system is formed wherein a vinyl-based polymerizable monomer such as styrene or an acrylate as well as a condensation reaction-based polymerizable monomer such as a polyvalent carboxylic acid or a polyol coexist; (2) a polyester resin is initially formed via polycondensation of the polyvalent carboxylic acid and the polyol; and then (3) a vinyl resin is formed via radical polymerization of the vinyl-based polymerizable monomer.

Further, the toner of the present invention is prepared via a process of preparing a colorant particle serving as a mother body of the toner by aggregating the composite resin particle.

A toner used in the present invention will further be described. The toner used for the two component developer of the present invention is composed of a resin formed, with a composite resin particle containing a polyester resin and a styrene-acryl resin. This composite resin particle is prepared as follows: initially, oil droplets containing styrene and an acrylate or a methacrylate are formed in an aqueous medium, followed by allowing a polyvalent carboxylic acid and a polyol to be contained therein; then a polyester resin is formed via polycondensation reaction in the aqueous medium; and after the formation of the polyester resin, a styrene-acryl resin is formed via radical polymerization of a polymerizable monomer, as described above. In this way, prepared is the composite resin particle featuring a particle diameter of about 100 nm, wherein a polyester resin and a styrene-acryl resin are mixed.

In the present invention, a polyester resin is formed via dehydration reaction of a carboxylic group of a polyvalent carboxylic acid with a hydroxyl group of a polyol in oil droplets formed with a vinyl-based polymerizable monomer such as styrene or an acrylate dispersed minutely in an aqueous medium. In this way, it is assumed that via polycondensation reaction of employing a system, enabling to block water, which is oil droplets formed with a vinyl-based polymerizable monomer, a polyester resin can be prepared in the system where water exists, which is likely to inhibit progress of esterification reaction.

Then, it is assumed that via formation of a colorant particle, serving as a toner mother body, by aggregating a composite resin particle containing a polyester resin and a styrene-acryl resin, a minutely uniform dispersion containing a polyester resin and a styrene-acryl resin is formed at the level that can hardly be reached by pulverized toners. In this way, it is assumed that in the toner used in the present invention, a minutely uniform dispersion state formed with a polyester resin and a styrene-acryl resin is realized, although conventional technologies have made it difficult to form the above uniform dispersion state due to the difference in molecular structure and polarity between both resins. Then, the composite resin particle formed in such a minutely uniform dispersion state features a particle diameter at a level of 100 nm, and is aggregated to form the toner.

Therefore, no so-called phase-separated structure is formed, which is a structure where a polyester resin and a styrene-acryl resin are localized in the toner, whereby a soft resin portion exhibiting weak mechanical strength tends not to peel off even when the carrier and the toner contact each other, resulting in no carrier contamination caused by the toner.

Further, a production method of the toner used in the present invention will now be described.

The toner used in the present invention is one which can be produced via a production method of the toner as detailed below, which can be produced as a toner referred to as a so-called polymerized toner. Namely, the toner is composed of a colorant particle (being a toner in the state prior to external additive treatment) formed by aggregating a composite resin particle containing both a polyester resin and a styrene-acryl resin, together with a colorant particle, if appropriate.

An example of the production method of the toner used in the present invention is described. Initially, oil droplets of a composite resin particle-forming composition are formed in an aqueous medium containing a surfactant containing a compound formed with a long-chain hydrocarbon group and an acid group (hereinafter referred to also as “an acid group-containing surfactant). These oil droplets are composed of a polycondensation monomer forming the polyester resin and a radical polymerizable monomer forming the styrene-acryl resin. Herein, the polycondensation monomer contains at least one type of carboxylic acid of at least divalence (hereinafter referred to as “a polyvalent carboxylic acid”) and at least one type of alcohol of at least divalence (hereinafter referred to as “a polyol”). Further, the radical polymerizable monomer contains at least one type of styrene compound and at least one type of acrylate compound or methacrylate compound.

In the oil droplets formed, the following polymerization reaction is carried out: namely, a polycondensation process is initially carried out, wherein a polyester resin is formed via polycondensation of a polyvalent carboxylic acid and a polyol; and a radical copolymerization process is carried out, wherein a styrene-acryl resin is formed via radical copolymerization of a radical polymerizable monomer. In this way, a composite resin particle containing a polyester resin and a styrene-acryl resin is formed. Further, an aggregation process is carried out, wherein a colorant particle (being a toner in the state prior to external additive treatment) is formed via aggregation of the thus-formed composite resin particle and a colorant in an aqueous medium.

An example of the preparation method of toner is composed of the following processes.

(1) Oil droplet forming process in which a composition for forming composite resin particles is dispersed in an aqueous medium containing a surfactant. A composition for forming composite resin particles is prepared by mixing polycondensable monomers containing a polycarboxylic acid and a polyalcohol, and a radically polymerizable monomers containing styrene and an acrylate ester or methacrylate ester. The oil droplet is formed by dispersing the composition forming composite resin particles in an aqueous medium containing a surfactant in this process.

(2) Polymerization process in which the composite resin particle dispersion is prepared by polymerization-treatment of a water based dispersion of the composition for forming composite resin particles. Polyester resin is formed by polycondensation of polycarboxylic acid and polyalcohol at first, then styrene-acrylic resin formed by radical polymerization of styrene compound and acrylate or methacrylate, whereby the composite resin particles composed of the both resins.

(3) Coagulation process in which colored particles as toner components including the resulting composite resin particles, colorant particles, and wax particles or charge control agent particles if desired are coagulated and fused in the aqueous medium to form colored particles (toner before process of addition of external additive).

(4) Filtrating/washing process in which the resulting colored particles are filtrated from the aqueous medium, and an unnecessary ingredient such as the surfactant is removed from the colored particles via washing.

(5) Drying process in which the colored particles are dried following the washing treatment.

The colored particles may be used as toner, and further it is possible to add the step (6) external additive addition process in which external additives are added into the colored particles.

Each process is detailed below.

### (1) Oil Droplet Forming Process

Oil droplets are formed, in which a composition for forming composite resin particles containing polycarboxylic acid and polyalcohol, styrene compound and (meth)acrylate is added into an aqueous medium in which surfactant of not more than critical micelle concentration is dissolved, and dispersed utilizing mechanical energy. An acrylate compound and a methacrylate compound, which are radical polymerizable monomers, are called “(meth)acrylate compound” including both. A styrene-acrylate and a styrene-methacrylate are called “a styrene-(meth) acrylate” including both in the similar manner.

The homogenizer to disperse oil droplets by mechanical energy is not specifically limited, for example, a stirring apparatus CLEARMIX, manufactured by M Technique Co., Ltd., having a high speed rotating rotor, a ultrasonic dispersing apparatus, a mechanical homogenizer, Manton-Gaulin homogenizer and a pressure type homogenizer are usable.

The number average primary particle diameter of the oil droplets after dispersing is preferably 50-500 nm, and more preferably 70-300 nm.

“Aqueous medium” means an aqueous medium containing water of at least 50% by weight. Water soluble solvents other than water may be employed as components. Examples of these solvents include methanol, ethanol, isopropanol, butanol, acetone, methyl ethyl ketone, and tetrahydrofuran, of which preferred are alcohol based organic solvents such as methanol, ethanol, isopropanol, and butanol, which do not dissolve the resins.

The surfactant used in the manufacturing method of the resin particles is preferably an acidic group-containing surfactant which contains a hydrophobic group composed of a long chain hydrocarbon group and a hydrophilic group composed of an acidic group.

“Long chain hydrocarbon group” means a hydrocarbon group structure having a carbon number of 8 or more in the backbone. The long chain hydrocarbon group includes an alkyl group and an aromatic hydrocarbon group which may contain an alkyl group each having a carbon number of 8-40, and in particular, a phenyl group having an alkyl group having a carbon number of 8-30 among them.

An acidic group constituting this acidic group-containing a surfactant which exhibits high acidity is preferably employed, of which a sulfonic acid group, a carboxylic acid group, and a phosphoric acid group, as examples, are employed, of which a sulfonic acid group is preferably used. The surfactant preferably has pKa of riot more than 2.

Sulfonic acid, carboxylic acid and phosphoric acid, each possessing a long chain hydrocarbon group are specifically preferable as an example of the acidic group-containing surfactant. The most preferable example is sulfonic acid.

Provided as specific examples can be sulfonic acids such as dodecyl sulfonic acid, eicosyl sulfonic acid, decyl benzenesulfonic acid, dodecylbenzenesulfonic acid, as well as eicosyl benzenesulfonic acid, carboxylic acids such as dodecyl carboxylic acid and the like, in addition to phosphoric acid such as dodecyl phosphoric acid and eicosyl phosphoric acid. Compounds of the foregoing sulfonic acid are specifically preferable.

While the acidic group-containing surfactant is a surfactant in which an acidic group and a long chain hydrocarbon group are bonded via various inorganic groups or organic groups, it is preferred that the acidic group and the long chain hydrocarbon group are directly bonded. The reason has not yet been clear, however, it is presumed as follows: In an aqueous medium, stably established are the orientation of the acidic group to the aqueous medium (water phase) and the orientation of the hydrophobic group to an oil droplet (oil phase) containing a composition forming composite resin particles, when a surfactant has a structure in which a long chain hydrocarbon group as a hydrophobic group and an acidic group as a hydrophilic group are directly bonded, whereby stable oil droplets are acquired and water produced in a polycondensation reaction can effectively be evacuated into the water phase.

It is preferred that concentration of this acidic group-containing surfactant contained in the aqueous medium is not more than the critical micelle concentration. Stable oil droplets can be formed with no micelle formation when concentration of the acidic group-containing surfactant contained in the aqueous medium is not more than the critical micelle concentration. It is also assumed that in the case of stable oil droplet formation, the entire surfactant is appropriately oriented around the oil droplets caused by no excessive amount of surfactant, and the reaction rate of polycondensation can be increased via such an appropriate orientation by assuredly improving a function as a catalyst for dehydration during the polycondensation reaction in a polymerization process described in following polymerization process.

In general, the concentration of an acidic group-containing surfactant contained in the aqueous medium is commonly not more than the critical micelle concentration, specifically at most 80% of the critical micelle concentration, and is preferably at most 70% of critical micelle concentration, however, the concentration of an acidic group-containing surfactant is not limited thereto. The lower limit of the acidic group-containing surfactant content is the content for allowing to work as a catalyst in the polycondensation reaction to polymerize the polyester including this lower limit, the acidic group-containing surfactant content is 0.01-2% by weight, and preferably 0.1-1.5% by weight, based on the weight of the aqueous medium.

An anionic surfactant or a nonionic surfactant may appropriately be contained in an aqueous medium to stabilize oil droplets containing the composition forming composite resin particles.

The practical examples of the polycondensable monomer contained in the composition for forming composite resin particles which composes oil droplet are described.

The polycarboxylic acid in the polycondensable monomer contained in the composition forming composite resin particles employed in the preparation of the toner is a two or more valent carboxylic acid, including an aliphatic or aromatic dicarboxylic acid, carboxylic acids of three or more valent, and anhydride or chloride thereof, such that described below.

### (a) Example of Aliphatic Dicarboxylic Acid.

Oxalic acid, malonic acid, succinic acid, glutaric acid, adipic acid, pimelic acid, suberic acid, azelaic acid, sebacic acid, maleic acid, fumaric acid, citraconic acid, itaconic acid, glutaconic acid, n-dodecyl succinic acid, n-dodecenyl succinic acid, isododecyl succinic acid, isododecenyl succinic acid, n-octyl succinic acid, and n-octenyl succinic acid.

### (b) Example of Aromatic Dicarboxylic Acid.

Phthalic acid, isophthalic acid, terephthalic acid, and naphthalene dicarboxylic acid.

### (c) Example of Carboxylic Acid of Three or More Valent.

Trimellitic acid, pyromellitic acid.

The above polycarboxylic acid can be used singly or in combination of at least two kinds.

In the case of employing carboxylic acids of trihydric or more as the polycarboxylic acid, composite resin particles having a cross-linking structure can be acquired via a polymerization process. The content of carboxylic acid of trihydric or more is preferably 0.1-10% by weight, based on the entire polycarboxylic acid amount.

A polyalcohol in the polycondensable monomer contained in the composition forming composite resin particles employed in the method of manufacturing toner is alcohol of divalent or more.

### (a) Diols.

Provided, for example, are diols such as ethylene glycol, diethylene glycol, triethylene glycol, 1,2-propylene glycol, 1,3-propylene glycol, 1,4-butanediol, 1,4-butylene diol, neopentylglycol, 1,5-pentane glycol, 1,6-hexane glycol, 1,7-heptane glycol, 1,8-octanediol, 1,9-nonane diol, 1,10-decane diol, pinacol, cyclopentane-1,2-diol, cyclohexane-1,4-diol, cyclohexane-1,2-diol, cyclohexane-1,4-dimethanol, dipropylene glycol, polyethylene glycols, polypropylene glycol, polytetramethylene glycol, bisphenol A, bisphenol Z, and hydrogen-added bisphenol A.

### (b) Aliphatic Polyalcohols of Trihydroxylic or More.

Glycerin, trimethylol ethane, trimethylol propane, pentaerythritol, sorbitol, trisphenol PA, phenol novolak, and cresol novolak.

### (c) Alkylene Oxide Addition Products of the Foregoing Aliphatic Polyalcohol of Trihydroxylic or More.

The particularly preferable alcohol is neopentylglycol or bisphenol A.

The polyalcohol can be used singly or in combination of at least two kinds. In the case of employing aliphatic polyalcohol of trihydric or more, or its alkylene oxide addition product as the polyalcohol, composite resin particles having a cross-linking structure can be acquired via a polymerization process.

The content of aliphatic polyalcohol of trihydric or more, or its alkylene oxide addition product is preferably 0.1-10% by weight, based on the entire polyalcohol amount.

In view of the ratio of the above-mentioned polyalcohol to polycarboxylic acid, an equivalent ratio of [OH]/[COOH] is preferably 1.5/1-1/1.5, and more preferably 1.2/1-1/1.2, where [OH] indicates hydroxyl groups in the polyalcohol, and [COOH] indicates carboxyl groups in the polycarboxylic acid.

Polyester resin having a desired molecular weight can be assuredly acquired by arranging to set the ratio of polyalcohol to polycarboxylic acid in the above range.

The monomer of the composition forming composite resin particles may contain very small amount of at least one of a monocarboxylic acid and a monoalcohol in addition to the polycarboxylic acid and the polyalcohol. These monocarboxylic acid and monoalcohol work as a polymerization stopper in a polycondensation reaction conducted in oil droplets. Accordingly, the molecular weight of the polyester resin can be controlled by the added amount of these compounds.

In the production method of the toner, the content of polycondensable monomer is preferably 10 90% by weight, and more preferably 20-80% by weight based on the weight of the whole composition forming composite resin particles of the invention. When the content of the polycondensable monomer is too small, the effect of the viscoelasticity due to the polyester resin may not be fully obtained in the toner, resulting in causing offset in a fixing process, while, when the content of the polycondensable monomer is too much, the excellent low temperature fixability due to the styrene-(meth)acrylate resin, which will be described later, may not be obtained, whereby the fixing property may be deteriorated.

Examples of the radical polymerizable monomer composing the composition for forming the composite resin particles forming the oil droplets are described.

Examples of a styrene compound as the radically polymerizable monomer contained in the composition of the invention include styrene monomers and styrene derivatives such as: styrene, o-methylstyrene, m-methylstyrene, p-methylstyrene, α-methyl styrene, p-chlorostyrene, 3,4-dichlorostyrne, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecyl styrene.

These styrene monomers or styrene derivatives can be used alone or in combination of two or, more monomers.

The content of the styrene compound is not specifically limited, however, it is preferably 40-95% by weight, and more preferably 50-80% by weight, based on the total weight of the radically polymerizable monomers, in order to adjust the softening temperature and the glass transition temperature of the styrene-(meth)acrylate resin.

Examples of a (meth)acrylate ester compound as a radically polymerizable monomer contained in the composition of the invention include the followings.

### (a) Acrylate Compounds

Methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate.

### (b) Methacrylate Compounds

Methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate.

These acrylate compounds and methacrylate compounds can be used alone or in combination of two or more monomers.

The content of the (meth)acrylate ester compound is not specifically limited, however, it is preferably 5-60% by weight, and more preferably 10-50% by weight, based on the total weight of the radically polymerizable monomers, in order to adjust the softening temperature and the glass transition temperature of the styrene-(meth)acrylate resin.

The radically polymerizable monomer may contain a compound which has an ionically dissociable group. The compound which has an ionically dissociable group means a compound having a substituent such as a carboxyl group, a sulfonic acid group, and a phosphate group, as a constituent group of the monomer.

(a) Practical Examples those Containing a Carboxylic Acid.

Acrylic acid, methacrylic acid, maleic acid, itaconic acid, cinnamic acid, fumaric acid, maleic acid monoalkyl ester, and itaconic acid monoalkyl ester.

(b) Practical Examples those Containing a Sulfonic Acid.

Styrene sulfonic acid, allylsulfosuccinic acid, 2-acrylamide-2-methylpropane sulfonic acid.

(c) Practical Examples those Containing a Phosphoric Acid.

Acid phosphoxyethyl methacrylate, 3-chloro-2-acid and phosphoxypropyl methacrylate.

Further, the radically polymerizable monomer may contain a multifunctional vinyl compound. Examples of the multifunctional vinyl compound include compounds having two or more unsaturated bonds such those shown below.

Divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylglycol dimethacrylate, and neopentylglycol diacrylate. These monomers can be used alone or in combination of two or more monomers. The radically polymerizable monomer containing a multifunctional vinyl compound enables to form a cross-linking styrene-(meth)acrylate resin via a radical copolymerization process.

The content of the multifunctional vinyl compound is selected according to the extent of elasticity desired in the styrene-(meth)acrylate resin, and, the content is preferably 0.01-10% by weight, and more preferably 0.02-5% by weight based on the total weight of radically polymerizable monomers. When the content of the multifunctional vinyl compound is too large, the styrene-(meth)acrylate resin is highly cross-linked and the softening temperature becomes too high, whereby the fixability of the toner is deteriorated, while, when the content of the multifunctional vinyl compound is too small, the copolymer is not fully cross-linked and the effect of cross-linking is not fully obtained.

The composition of the invention (the composition for forming composite resin particles of the invention) used in the production process of the toner of the present invention may contain a polymerization initiator in order to form radicals which initiate radical copolymerization in each oil droplet.

As such a polymerization initiator, an oil-soluble polymerization initiator may be used, examples of which include azo polymerization initiators and diazo polymerization initiators illustrated below.

### (a) Azo or Diazo Polymerization Initiator

2,2′-azobis-(2,4-dimethylvaleroitrile), 2,2′-azobis-isobutyronitrile, 1,1′-azobis-(cyclohexane-1-carbonitrile), 2,2′-azobis-4-methoxy-2,4-dimethylvaleronitrile, and azobisisobutyronitrile.

### (b) Peroxide Polymerization Initiators and Polymer Initiators Having a Peroxide in a Side Chain.

Benzoyl peroxide, methylethylketone peroxide, diisopropylperoxy carbonate, cumenehydroperoxide, t-butylhydroperoxide, di-t-butylperoxide, dicumylperoxide, 2,4-dichlorobenzoylperoxide, lauroylperoxide, 2,2-bis-(4,4-t-butylperoxycyclohexyl)propane, and tris (t-butylperoxy)triazine.

In addition to the oil-soluble polymerization initiator incorporated in the oil droplets, a water-soluble polymerization initiator may also be added into tie aqueous medium, whereby radicals which initiate the polymerization reaction are produced not only in the oil droplets but also in the aqueous medium to supply to the oil droplets.

Examples of a water soluble polymerization initiator include: persulfates such as potassium persulfate and ammonium persulfate; azobisaminodipropane acetate; azobiscyanovaleric acid and its salt; and hydrogen peroxide.

Alternatively, the polymerization initiator may be incorporated only in the aqueous medium, without being added to the oil droplets, to produce radicals only in the aqueous medium and to supply to the oil droplets.

In the production method of the toner of the present invention, the content of the radically polymerizable monomer is preferably 10-90% by weight, and more preferably 20-80% by weight, based on the total weight of the composition for forming composite resin particles of the present invention. When the content of the polymerizable monomer is too much, the excellent low temperature fixability due to the styrene-(meth)acrylate resin, which will be described later, may not be obtained, whereby the fixing property may be deteriorated, while, when the content of the polymerizable monomer is too small, the effect of the viscoelasticity due to the polyester resin may not be fully obtained in the toner, resulting in causing offset in a fixing process.

The composition forming composite resin particles used in the method of manufacturing toner may contain various oil-soluble components such as organic solvents. Provided as such the organic solvent, for example, may be toluene, ethyl acetate, and others, which exhibit low water-solubility in addition to a low boiling point.

The composition forming composite resin particles used in the method of manufacturing toner may contain colorants or wax. Composite resin particles colored in advance or containing wax in advance can he acquired via polymerization, employing a composition forming composite resin particles containing colorants or wax. The content of wax is 2-20% by weight, based on the entire composition forming composite resin particles amount, preferably 3-18% by weight, and is more preferably 4-15% by weight.

### (2) Polymerization Process

Two kinds of polymerization are carried out in oil droplets which is formed and dispersed via oil droplets forming process in the aqueous medium, and the composite resin particles in which a polyester resin and a styrene-(meth)acrylate resin are mixed with, high uniformity. The polymerization process is composed of a polycondensation process in which a polycarboxylic acid and a polyalcohol are polycondensed to form a polyester resin and a radical copolymerization process in which a styrene compound and a (meth)acrylate ester compound are radically polymerized to form a styrene-(meth)acrylate resin. The polymerization process and the radical condensation process are described more in detail.

### (2-1) Polycondensation Process

The polycondensation process is carried out in an aqueous medium containing a surfactant containing a acidic group. The reason why the polycondensation process is carried out in an aqueous medium is assumed as follows. The hydrophilic group composed of acidic groups and the hydrophobic group composed of a long chain hydrocarbon group in the acidic group-containing surfactant on the surface of formed oil droplets are oriented in the water phase and in the oil phase, respectively. It is assumed that water produced in a polycondensation reaction can be removed from the oil droplets by employing the acidic group existing on the boundary surface between this oil droplet and water phase as a catalyst for dehydration, and as a result, the polycondensation reaction together with oil droplets in the aqueous medium is promoted.

Depending on kinds of the polycarboxylic acid and the polyalcohol contained in the composition forming composite resin particles, the polymerization temperature to conduct polycondensation treatment is usually not less than 40° C., preferably 50-150° C., and more preferably 50-100° C. in view of treatment at a target temperature below the boiling point of water in the aqueous medium. Depending on the reaction rate of polycondensation to form composite resin particles, the reaction time of polymerization is typically 4-10 hours.

The weight average molecular weight (Mw) of polyester resin prepared via the polycondensation process is not less than 10,000, preferably 20,000-10,000,000, and more preferably 30,000-1,000,000. These values are determined employing gel permeation chromatography (GPC). In the case of a weight average molecular weight of less than 10,000, a problem of offset at high temperature may be produced in the fixing process for an image formation operation employing the toner.

A number average molecular weight (Mn) of these polyester resin is at most 20,000, preferably 1,000-10,000, and more preferably 2,000-8,000. These values are determined employing gel permeation chromatography (GPC). In the case of a number average molecular weight exceeding 20,000, neither fixability at low temperature in a fixing process for an image formation operation employing the toner, nor desired glossiness of images acquired via image formation when the color toner is used can also be obtained.

The polyester resin preferably has a glass transition temperature of 20-90° C. and a softening temperature of 80-220° C., and more preferably has a glass transition temperature of 20-80° C. and a softening temperature of 80-150° C. The glass transition temperature is determined employing an on-setting technique when increasing the temperature in the second run via a differential thermal analysis method, while the softening temperature is determined using a flow tester proposed by “The Society of Polymer Science, Japan” and produced by Shimadizu Corp., employing a ½ method.

### (2-2) Radical Copolymerization Process

In the radical copolymerization process, the radical copolymerization is initiated by the radicals produced by the polymerization initiator in the oil droplets and/or by the radicals produced by the polymerization initiator in the aqueous media and supplied to the oil droplets.

The polymerization temperature of the radical copolymerization depends on the styrene compound and the (meth)acrylate ester compound contained in the composition of the invention, and also on the polymerization initiator which produces radicals. The polymerization temperature is usually 55-90° C., preferably 50-100° C., and more preferably 3-20° C. The duration of polymerization depends on the reaction rate of the radical copolymerization of the styrene, (meth)acrylate resin, and it is usually 5 to 12 hours.

The weight average molecular weight (Mw) of the styrene-(meth)acrylate resin obtained in the radical copolymerization is preferably 2,000-1,000,00. The number average molecular weight (Mn) of the resin is preferably 1,000-100,000.

The distribution of molecular weight (Mw/Mn) is preferably 1.5-100, and specifically preferably 1.8-70. When a toner having the weight average molecular weight (Mw), the number average molecular weight (Mn) and the distribution of molecular weight (Mw/Mn) lying in the above described ranges is used in an image forming method, occurrence of offset in the fixing process is suppressed.

The glass transition temperature of the styrene-(meth)acrylate resin obtained in the radical copolymerization is preferably 30-70° C., and the softening temperature of the resin is preferably 80-170°C. The toner having the glass transition temperature and the softening temperature lying in the above described range exhibits a excellent fixability.

In the above polymerization process, the polycondensation to form the polyester is preferably carried out, first, followed by starting the radical copolymerization under the existence of the polyester resin.

### (3) Coagulation Process

A coagulation dispersion is prepared by mixing a dispersion of composite resin particles obtained via above-mentioned polymerization process and a dispersion of colorant particles or that of wax particles, charge control agent particles, or toner constituent particles if desired, and composite resin particles, colorant particles and such are coagulated and fused in the aqueous medium to form a colored particle dispersion in the coagulation process.

Practically the salting-out treatment is conducted by adding coagulants having a concentration of at least the critical coagulation concentration into the coagulation dispersion, and simultaneously stirring them in a reaction apparatus (refer to FIG. 1) equipped with stirring blades described later in a stirring mechanism, while the heat-fusing treatment is conducted at a temperature higher than the glass transition temperature of the polyester resin and styrene-(meth)acrylate resin forming the composite resin particles. Then, while forming coagulated particles, the particle diameter is allowed to gradually increase, when the particle diameter reaches the desired value, particle growth is stopped by adding a relatively large amount of water, and the resulting particle surface is smoothed via further heating and stirring, to control the shape to form colored particles.

Further, herein, coagulants as well as organic solvents, which are infinitely soluble in water, may be Simultaneously added into the coagulation dispersion Also provided, for example, can be coagulation aids such as calcium hydroxide, soda ash, bentonite, fly ash, and kaolin.

Particles such as composite resin particles, colorant particles and wax are coagulated in this process. Coagulants to be employed are not specifically limited, but coagulants selected from metal salts are preferable.

Examples of specific metal salts include a salt of monovalent metal such as sodium, potassium, or lithium, a salt of divalent metal such as calcium, magnesium, or copper, and a salt of trivalent metal such as aluminum and the like. Examples of specific salts include sodium chloride, potassium chloride, lithium chloride, calcium chloride, magnesium chloride, zinc chloride, copper sulfate, magnesium sulfate, and manganese sulfate. Of these, a salt of divalent metal is most preferable. In the case of using the salt of divalent metal, the coagulation process can be achieved with only a small amount of coagulants. These can also be used singly or in combination of at least two kinds.

These coagulants are preferably added into the coagulation dispersion in an amount higher than the critical coagulation concentration. The added amount is preferably at least 1.2 times that of the critical coagulation concentration, and more preferably at least 1.5 times.

The critical coagulation concentration, as described here, refers to an index regarding the stability of water based dispersion and concentration at which coagulation occurs through the addition of coagulants. The critical coagulation concentration varies depending on the dispersed particle components. The critical coagulation concentration is described in, for example, Seizo Okamura, et al., “Kobunshi Kagaku (Polymer Chemistry) 17, 601 (1960) edited by Kobunshi Gakkai, and other publications. Based on such publications, it is possible to obtain detailed critical coagulation concentration data. Further, as another method, a specific salt is added to a targeted particle dispersion while varying the concentration of the salt; the ξ potential of the resulting dispersion is measured, and the critical coagulation concentration is also determined as the concentration at which the ξ potential value varies.

Those solvents which do not dissolve a formed composite resin are selected as organic solvents infinitely soluble in water. Specifically listed may be methanol, ethanol, 1-propanol, 2-propanol, ethylene glycol, glycerin, acetone, and the like, but alcohol of at most 3 in carbon number such as methanol, ethanol, 1-propanol, or 2-propanol is preferable, and 2-propanol is specifically more preferable.

The added amount of the infinitely soluble organic solvents in this water is preferably 1-100% by volume, based on the coagulation dispersion into which coagulants are added.

In the coagulation process, the period of standing time after addition of coagulants is preferred to be as short as possible. Namely, it is preferable that the coagulation dispersion is heated as quickly as possible after addition of coagulants, and then heated to at least the glass transition temperature of the polyester resin and styrene-(meth)acrylate resin forming the composite resin particles or higher. The reason why this is most effective has not yet been determined. However, problems may be produced, in which the state of coagulated particles varies depending on the elapsed standing time, whereby an unstable particle diameter distribution of the resulting toner particles possibly occurs and the surface condition tend to fluctuate. The standing time is commonly within 30 minutes, and is preferably within 10 minutes. The temperature, at which coagulants are added, is not specifically limited, but preferably the glass transition temperature of composite resin particles or less.

Further, it is preferred that in the coagulation process, the temperature is quickly increased via heating, and the rate of temperature increase is preferably at least 1° C./minute. There is specifically no upper limit in a rate of temperature increase, but the rate of temperature increase is preferably at most 15° C./minute in view of inhibiting coarse grain formation caused by the accelerated fusing process. After the coagulation dispersion is also heated to the glass transition temperature or more, it is important to continuously conduct the fusing process while maintaining the coagulation dispersion temperature for the duration of the process. By this, the step of grown colored particles (coagulation of composite resin particles and colorant particles) and the step of fusing (disappearance of a boundary between particles can be effectively accelerated, whereby durability of the resulting toner can be enhanced.

Colorants wax and so on which may be coagulated in a form of particle together with the composite resin particles are described.

The colorant is described.

The colorant particle dispersion can be prepared by dispersing colorants in an aqueous medium. The dispersion process of colorants is preferably conducted with the surfactant concentration being not less than the critical micelle concentration, since colorants are evenly dispersed. Apparatuses employed for colorant dispersion treatment are not specifically limited, but those used in foregoing oil droplet forming process can be provided. Surfactants utilized here are not also limited, but the following anionic surfactants can preferably be employed.

Examples of anionic surfactants include the following sulfonic acid salts, sulfuric acid salts and fatty acid salts.

(1) Sulfonic acid salts: Sodium dodecylsulfonate, sodium dodecylbenzenesulfonate, sodium arylalkyl polyethersulfonate, sodium 3,3-disulfondiphenylurea-4,4-diazo-bis-amino-8-naphthol-6-sulfonate, sodium 2,2,5,5-tetramethyl-triphenylmethane-4,4-diazi-bis-β-naphthol-6-sulfonate and the like.

(2) Sulfuric acid salts: Sodium dodecylsulfonate, sodium tetradecylsulfonate, sodium pentadecylsulfonate, sodium octylsulfonate and the like.

(3) Fatty acid salts: Sodium oleate, sodium laureate, sodium caprate, sodium caprylate, sodium caproate, potassium stearate, calcium oleate and the like.

The colorants are described.

The following black colorants are employed, carbon black such as furnace black, channel black, acetylene black, thermal black, lamp black and further magnetic materials such as magnetite and ferrite.

Employed as magenta or red colorants may be C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122,C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Employed as orange or yellow colorants may be C.I. Pigment Orange 31, C.I. Pigment Orange 43, C.I. Pigment 12, C.I. Pigment Yellow 13, C.I Pigment Yellow 14, C.I. Pigment Yellow 15, C.I. Pigment Yellow 17, C.I. Pigment Yellow 93, C.I. Pigment Yellow 94, and C.I. Pigment Yellow 138

Employed as green or cyan colorants may be C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Blue 62, C.I. Pigment Blue 66, and C.I. Pigment Green 7.

The colorant may be used singly or in mixtures if necessary. The amount of the colorant is 1-30 wt %, preferably 2-20 wt % of the whole toner.

Examples of such waxes include

(1) polyolefin waxes such as polyethylene wax or polypropylene wax;

(2) long hydrocarbon chain based waxes such as paraffin wax or sazole wax;

(3) dialkyl ketone based waxes such as distearyl ketone;

(4) ester based waxes such as carnauba wax, montan wax, trimethylolpropane tribehenate, pentaerythritol tetrabehenate, pentaerythritol tetrastearate, pentaerythritol diacetate dibehenate, glycerin tribehenate, 1,18-octadecanediol distearate, tristearyl trimellitate, or distearyl maleate; and

(5) Amido based waxes such as trimellitic acid tristearylamide.

The melting point of wax is commonly 40-160° C., preferably 50-120° C., and more preferably 60-90° C. When the melting point is set within the above range, not only heat resistance storage stability of toner is obtained, but also stable toner image formation can be conducted with no occurrence of cold off-setting in the case of fixing at low temperature.

The amount of waxes incorporated in toner is preferably 1-30% by weight with respect to the total toner, but is more preferably 5-20% by weight.

The wax can be used singly or two or more in combination.

Employed as charge control agents constituting charge control agent particles may also be various types which can be dispersed in an aqueous medium. Specifically listed are nigrosine based dyes, metal salts of naphthenic acid or, higher fatty acids, alkoxylated amines, quaternary ammonium salts, azo based metal complexes, salicylic acid metal salts or metal complexes thereof.

It is preferable that the number average primary particle diameter of the charge control agent particles is roughly between 10 and 500 nm in the dispersed state.

The reaction apparatus is described. In the case of toner composed of toner particles prepared via coagulation and fusion of composite resin particles, it is also possible to form toner having a targeted shape factor and a highly uniform shape distribution, by using stirring blades and a stirring tank which can create a flow in a reaction apparatus to be a laminar flow and can uniform inner temperature distribution, and by controlling the temperature, the number of revolutions and the duration of the coagulation process. The reason why toner having a highly uniform shape distribution can be produced is as follows: when the coagulation process is conducted in the field where a laminar flow has been formed, intensive stress is not applied to coagulated particles to which coagulation and fusion have been accelerated, and temperature distribution in the stirring tank is uniform in the accelerated laminar flow, whereby the shape distribution of coagulated particles becomes presumably uniformized. Further, the coagulated particles are gradually changed into spheres via the shape controlling process of heating and stirring, thus, the resulting colored particle shape can be optionally controlled.

The stirring blades and stirring tank employed during the production of toner composed of colored particles prepared via coagulation and fusion of composite resin particles are shown in FIG. 1, being as a preferable example.

The reaction apparatus is characterized in that the stirring blades are arranged at multiple levels in which the upper stirring blade is arranged so as to have a crossed axis angle α preceding in the rotation direction with respect to the lower stirring blade, and obstacles such as a baffle plate and the like, which form a turbulent flow, are not employed.

FIG. 1 is a perspective view of an example of the reaction apparatus.

In the reaction apparatus illustrated in FIG. 1, rotating shaft 3 is installed vertically in the center of vertical type cylindrical stirring tank 2, the exterior is equipped with heat exchange jacket 1, and rotating shaft 3 is provided with lower level stirring blade 4b installed near the bottom of stirring tank 2 and upper level stirring blade 4a. Upper level stirring blade 4a is arranged with respect to lower level stirring blade 4b at crossed axis angle α preceding in the rotation direction.

An arrow shows the rotation direction, numerals 7 and 8 designate upper material charging inlet and lower material charging inlet, respectively, in FIG. 1.

When the toner of the present invention is prepared, crossed axis angle α of stirring blades 4a and 4b is preferably less than 90 degrees. The lower limit of crossed axis angle α is not particularly limited, but it is preferably between 5° and 90°, but more preferably between 10° and 90°.

By employing the constitution as above, it is assumed that, firstly, the coagulation dispersion is stirred employing stirring blade 4a provided at the upper level, whereby a downward flow is formed. It is also assumed that subsequently, the downward flow formed by upper level stirring blade 4a is accelerated by stirring blade 4b Installed at a lower level, whereby another flow is simultaneously formed by stirring blade 4a, and as a whole, accelerating the -Laminar flow.

The shape of the stirring blades is not particularly limited as long as they do not form a turbulent flow, but rectangular plates as shown in FIG. 1 which are formed of a continuous plane with no through-hole are preferred, and may have a curved plane.

By forming a non-turbulent flow of stirring blades, neither coagulation of composite resin particle-to-composite resin particle in the polymerization process is promoted, nor composite resin particles are dispersed again via destruction of resin particles. Excessive collision of the particles can be avoided in the coagulation process, thus evenness of the particle diameter distribution can also be enhanced, so that toner exhibiting a uniform particle diameter distribution results. Excessive coagulation of the particles can be controlled, so that toner exhibiting a uniform shape distribution can also be obtained.

### (4) Filtering/Washing Process

In the filtrating/washing process, carried out are a filtrating process of segregating colored particles from the colored particle dispersion obtained by the above coagulation process, and a washing process of removing adhered materials such as surfactants, coagulants and the like from filtrated colored particles (also known as caked aggregation).

The filtrating treatment methods are not particularly limited, but include a centrifugal separation method, a vacuum filtration method employing a Buchner funnel, a filtration method employing a filter press, and so forth.

### (5) Drying Process

The washed colored particles are then subjected to a drying process. Provided as a dryer used in this process i s a spray dryer, a vacuum-freeze dryer or a vacuum dryer. The moisture content of dried colored particles is preferably at most 1.0% by weight, but more preferably at most 0.5% by weight.

The moisture content of colored particles can be measured by the Karl-Fischer method. The moisture content measured after standing for 24 hours at a high-temperature and humidity of 30° C. and 85% RH is set to the moisture content of the colored particles, employing moisture content measuring apparatus AQS-724, manufactured by Hiranuma Sangyo Co., Ltd. which is used for samples specifically under a high-temperature and humidity condition of 30° C. and 85% RH and under a heating condition of samples at 110° C.

Further, when dried colored particles coagulate due to weak inter-particle attractive forces, aggregates may be subjected to pulverization treatment. Herein, employed as pulverization devices may be mechanical pulverization devices such as a jet mill, a Henschel mixer, a coffee mill, a food processor, and the like.

### (6) External Additive Addition Process

This external additive addition process is to be carried out to improve fluidity, chargeability, and the cleaning property of dried colored particles. Provided as devices to add external additives, may be various types of mixing devices such as a tubular mixer, a HENSCHEL MIXER, a Nauter mixer, a V-type mixer, and the like.

The addition amount of these external additives is 0.1-5.0% by weight hut preferably 0.5-4.0% by weight, based on the toner. External additives may also be used in combination with various appropriate substances.

Addition of the external additive improves the fluidity and chargeability of the toner, and realizes improvement of cleaning efficiency. External additives are not particularly limited, and various inorganic particles, organic particles, and lubricants can be utilized.

Inorganic oxide particles such as silica, titania, alumina and the like are preferably employed as inorganic particles.

Inorganic particle can be used as the external additive.

Fine particles of silica, titania and alumina are preferably usable. These inorganic particles may be treated to be hydrophilic.

Concrete examples of the silica fine particle include R-976, R-974, R-972, R-812 and R-809 each manufactured by Nihon Aerosil Co., Ltd., HVK-2150 and H-200, each manufactured by Hoechst Co., Ltd., and TS-720, TS-530, TS-610, H-5 and MS-5, each manufactured by Cabot Co., Ltd.

Concrete examples of the titania fine particle include MT-100S, MT-100B, MT-500BS, MT-600, MT-600SS and JA-1, each manufactured by Teika Co. Ltd., and TA-300SI, TA-500, TAF-130, TAF-510 and TAF-510T, each manufactured by Fuji Titan Co., Ltd., and IT-S, IT OA, IT-OB and IT-OC, each manufactured by Idemitsu Kosan Co., Ltd.

Concrete examples of the alumina fine particle include RFY-C and C-604, manufactured by Nihon Aerosil Co., Ltd., and TTO-55, manufactured by Ishihara Sangyo Co., Ltd.

An organic particle having a sphere shape and a number average primary particle diameter of approximately from 10 to 200 nm can be used as the external additive. The material of such the particle is, for example, polystyrene, poly(methyl methacrylate) or a styrene-methyl methacrylate copolymer.

These inorganic particles are preferably subjected to hydrophobic treatment employing a silane coupling agent or a titanium coupling agent.

The degree of hydrophobic treatment is not specifically limited, but a range of 40-95 in methanol wettability is preferable. “Methanol wettability” means wettability measured against methanol. In this method, 0.2 g of targeted inorganic particles is weighed and added into 50 ml of distilled water charged into a 200 ml beaker. Methanol is slowly dripped from a burette, the top of which is immersed into the liquid, until the entire inorganic particles become wet while stirring slowly. The degree of hydrophobicity can be calculated by the following equations when the amount of methanol required to make inorganic particles completely wet is a ml.

Degree of hydrophobicity=[a/(a+50)]×100 Formula 1:

A lubricant may be used for improving cleaning efficiency or transfer efficiency. A metal salt of a higher fatty acid can be used as the external additive. Concrete examples of such the metal salt of higher fatty acid include a metal stearate such as zinc stearate, aluminum stearate, cupric stearate, magnesium stearate and calcium stearate; a metal oleate such as zinc oleate, manganese oleate, ferric oleate, cupric oleate and magnesium oleate; a palmitate such as zinc palmitate, cupric zinc palmitate, magnesium palmitate and calcium palmitate; a linoleate such as zinc linoleate and calcium linoleate; and a ricinolate such as zinc ricinolate and calcium ricinolate.

The volume-based median diameter (D₅₀) of the toner of the present invention is 3-8 μm. It is possible that small dot images constituting photographic images and fine lines are precisely reproduced by having a toner particle diameter in the foregoing range.

The volume-based median diameter (D₅₀) is measured according to the procedure described below.

The volume-based median diameter (D₅₀) of toner particles can be determined using Coulter Multisizer 3 (Beckmann Coulter Co.), connected to a computer system for data processing.

The measurement procedure is as follows: 0.02 g of toner particles are added to 20 ml of a surfactant solution (for example, a surfactant solution obtained by diluting a surfactant containing neutral detergent with pure water to a factor of 10) and dispersed by an ultrasonic homogenizer to prepare a toner dispersion. Using a pipette, the toner dispersion is poured into a beaker having ISOTON II (produced by Beckman Coulter Co.) within a sample stand, until reaching a measurement concentration of 7%. The measurement particle count number was set to 25,000 to perform measurement. Then aperture diameter of the Multisizer 3 was 50 μm. The measurement range of 1 to 30 μm was divided to 256 portions to determine the frequency number. The particle size corresponding to 50% of a volume-integrated fraction from the larger particles is defined as a volume-based median diameter.

A toner used in the present invention is employed for a so-called two component developer by mixing with a carrier. Also, in cases of forming the two component developer by mixing the toner with a carrier, an excellent toner image causing no image defects due to carrier contamination can be realized.

Further, a carrier usable for the two component developer of the present invention will now be described.

The carrier usable in the present invention has a given shape and a given size, as described below, wherein the shape factor SF-1 thereof is from 1.0-1.2; the shape factor SF-2 thereof is from 1.1-2.5; and the volume based median diameter thereof is 10 μm-100 μm. The carrier is composed of magnetic material powder dispersed in a binder resin.

The shape factors SF-1 and SF-2 defining the shape of the carrier usable in the present invention are described. Herein, the shape factor SF-1 represents the degree of circularity of a particle, and a particle, featuring a SF-1 value of 1.0, means that its shape is a perfect sphere.

Further, the shape factor SF-2 represents the degree of non-uniformity of a carrier particle, and a SF-2 value of 1.0 indicates a smooth surface wherein non-uniformity is absent on the surface of the carrier particle. The shape factors SF-1 and SF-2 are defined by the following equations.

SF-1=((maximum diameter of a toner)²/(projected area of the toner))×(π/4)

SF-2=((circumferential length of a toner)²/(projected area of the toner))×(¼π)

wherein the “maximum diameter” refers to a width that is the maximum distance between two parallel lines when a projected image of the carrier particle on a plane is sandwiched between the two parallel lines.

The shape factors SF-1 and Sf-2 of a carrier can be determined via the following steps: namely, using a scanning electron microscope, at least 100 carriers selected randomly are photographed at a magnitude of 200; and the obtained photographic image is read with a scanner, followed by analysis of the stored image data using an image analyzer to calculate a shape factor from the analyzed result. Incidentally, as an example of the specific scanning electron microscope, field emission scanning electron microscope “S-4500” (produced by Hitachi, Ltd.) is cited, and as a specific example of the image analyzer, “LUZEX 3” (produced by Nireco Corp.) is cited.

In the present invention, it is assumed that excellent image formation can stably be carried out by allowing the shape factors SF-1 and SF-2 of the carrier to be 1.0-1.2 and 1.1-2.5, respectively, whereby it is possible to produce an effect described below.

Namely, when the shape factor SF-1 falls within the range, adequate mobility is imparted to the carrier, resulting in efficient toner charging. Further, the imparting of adequate mobility to the carrier makes it possible to transport the carrier with no large force required in the developing device, whereby there is no possibility of breakage of the carrier in an image forming apparatus, leading to a prolonged life of the carrier. In this way, when the shape factor SF-1 of the carrier falls within the range, toner charging can efficiently be carried out, and also the carrier tends not to be broken in the image forming- apparatus, whereby it is anticipated to conduct excellent image formation.

Further, when the shape factor SF-2 falls within the above range, non-uniformity, which tends to impart an additional torque to the toner, is absent on the surface of the carrier, whereby charging can be conducted with no load applied to the toner. Therefore, the toner is charged via no load resulting from the carrier, whereby there is no possibility of undesired breakage of the toner, leading to stable charging application.

In this way, when the shape factor SF-2 falls within the above range, the toner tends not to be undesirably broken, whereby it is anticipated to conduct excellent image formation.

Still further, the volume based medium diameter (D50v) of the carrier usable in the present invention is from 10 μm-100 μm, preferably 20 μm 50 μm. A determination method of the volume based medium diameter of the carrier usable in the present invention includes one employing a laser diffraction-system particle size distribution meter equipped with a wet dispersing device as represented, for example, by “HELOS” (produced by SYMPATEC Co.).

When the volume based medium diameter of the carrier of the present invention is from 10 μm-100 μm, it is anticipated to produce an effect as described below. Initially, a state, where magnetic material powder is adequately dispersed in a carrier particle, is formed, whereby the carrier particle exhibits an appropriate intensity of magnetization. Accordingly, the carrier particle tends not to develop an electrostatic latent image on an image carrier. Further, when the volume based medium diameter of the carrier falls within the above range, a required specific surface area to stably carry the toner on the surface of the carrier is ensured, whereby toner charging can be certainly conducted at a predetermined level.

As a result, since no poorly charged toner exists in the image forming process, toner flies are prevented and also precise image reproduction of the original is realized, specifically reproduction of a solid image, which has been likely to have the difficulty in image reproduction due to poor charging, is ensured.

A carrier constituting the two component developer of the present invention features a structure wherein magnetic material powder is dispersed in a binder resin constituting the carrier particle.

As a typical form of the carrier featuring such a structure (hereinafter referred to as a resin dispersion-type carrier), exemplified is a carrier wherein magnetic material powder is dispersed in the binder resin prepared via polymerization treatment such as formation of a phenol-formaldehyde resin.

Such a resin dispersion-type carrier can be prepared via a, so-called polymerization method as described above. The resin dispersion-type carrier prepared via a polymerization method can readily be formed into a nearly perfect sphere, beings a shape which tends not Lo generate carrier contamination. Further, to the carrier of a nearly perfect sphere, uniformity of the surface of the carrier is easily realized, whereby enhanced charge-imparting performance is anticipated.

Further, the shape of the carrier can be controlled, for example, by selecting condition of stirring and temperature of the polymerization reaction during the polymerization method.

As a typical example of the resin dispersion-type carrier, a resin dispersion-type carrier employing a phenol-formaldehyde resin for the binder resin will now be described.

The resin dispersion type carrier employing a phenol-formaldehyde resin is prepared as follows: a phenol and an aldehyde serving as raw materials of the binder resin as well as magnetic material powder, to be described later, are added in an aqueous medium containing a dispersion stabilizer, followed by addition-condensation reaction carried out in the presence of an alkaline catalyst. Herein, the dispersion stabilizer added in the aqueous medium includes, for example, colloidal tricalcium phosphate, magnesium hydroxide, and hydrophilic silica.

Further, the alkaline catalyst added in the aqueous medium includes, for example, ammonia water, hexamethylenetetramine, and an alkylamine such as dimethylamine, diethylamine, or polyethyleneimine. The amount of these alkaline catalysts added is preferably from 0.02 mol-0.3 mol, for example, based on 1 mol of a phenol as a raw material.

Then, described are specific examples of the phenol and the aldehyde as raw materials to form a phenol-formaldehyde resin. Examples of the phenol include phenol and an alkylphenol such as m-cresol, p-tert-butylphenol, o-propylphenol, resorcinol, or bisphenol A.

Other than the above alkylphenols, any appropriate compound having a so-called phenolic hydroxyl group, formed by combining all aromatic ring with a hydroxyl group, may optionally be used. Specific examples of the compound having a phenolic hydroxyl group include, for example, a phenol halide wherein its benzene ring or alkyl group is partially or entirely substituted with a chlorine atom or a bromine atom. Of these, phenol, which ensures enhanced particle shape properties, is specifically preferable.

Further, specific examples of the aldehyde include formaldehyde in the form of either formalin or paraformaldehyde and furfural, but formaldehyde is preferable.

With regard to the resin dispersion-type carrier employing a phenol-formaldehyde resin made from a phenol and an aldehyde, described above, serving as raw materials, the surface of the carrier particle may be coated according to the charge amount of the toner to realize optimization of chargeability and the charge amount as well as enhanced durability. The coating treatment of the surface of the carrier particle may be carried out using a coating resin to be described later, and the coating may be conducted via addition of 0.1% by weight-10% by weight of the coating resin, preferably 0.3% by weight 5% by weight thereof based on the amount of the carrier particle. Incidentally, in order to allow the shape factors SF-1 and SF-2 of the carrier particle to fall within the above ranges, coating treatment conditions such as the amount of the coating resin added is preferably controlled.

Now, the coating resin is detailed. As the coating resin capable of coating the surface of the resin dispersion-type carrier, a thermoplastic or a thermocurable insulating resin can preferably be used.

The coating resin may be used individually or in combination, and the thermoplastic insulating resin may also be mixed with any appropriate hardener.

Magnetic material powder usable in the resin dispersion-type resin include, for example, powder containing a magnetic material such as iron, a ferrite represented by Formula (a), metal or a metal oxide such as a magnetite represented by Formula (b), an alloy of metal or a metal oxide thereof with metal such as aluminum or lead.

MO.Fe₂O₃ Formula (a):

MFe₂O₄ Formula (b):

In Formulas (a) and (b), M represents a divalent or a monovalent metal such as manganese (Mn), iron (Fe), nickel (Ni), cobalt (Co), copper (Cu), magnesium (Mg), zinc (Zn) or lithium (Li). These metals may be used individually or in combination.

A specific magnetic material constituting the magnetic material powder includes, for example, magnetite, γ-ferric oxide, Mn—Zn ferrite, Ni—Zn ferrite, Mn—Mg ferrite, Ca—Mg ferrite, Li ferrite, and Cu—Zn ferrite.

The content of magnetic material powder in the resin dispersion-type carrier is from 40%-99% by weight, preferably 50%-70% by weight.

Further, the size of the magnetic material powder is preferably from 0.1 μm-0.5 μm in terms of a number average primary particle diameter. The number average primary particle diameter of the magnetic material powder refers to an arithmetic average value obtained by calculating measured Fere axis diameters of 100 magnetic material powder in an electron microscope photograph taken at a magnitude of 10,000.

To adjust magnetic properties, it is also possible to add nonmagnetic metal oxide powder formed employing the following nonmagnetic metals individually or in combination to the magnetic material powder. Specific examples of the nonmagnetic metals include Mg, Al, Si, Ca, Sc, Ti, V, Cr, Mn, Fe, Co, Ni, Cu, Zn, Sr, Y, Zr, Nb, Me, Cd, Sn, Ba, and Pb. Further, specific examples of the nonmagnetic metal oxide powder include Al₂O₃, SiO₂, CaO, TiO₂, V₂O₅, CrO₂, MnO₂, Fe₂O₃, CoO, NiC, CuO, ZnO, SrO, Y₂O₃, and ZrO₂.

The size of the nonmagnetic metal oxide powder is preferably from 0.1 μm 1.0 μm in terms of a number average primary particle diameter. The number average primary particle diameter of the nonmagnetic metal oxide powder can be determined in the same manner as for the magnetic material powder. Further, the content of the nonmagnetic metal oxide powder in the resin dispersion-type carrier is from 10% by weight 60% by weight, preferably from 20% by weight-40% by weight.

In order to enhance lipophilic properties (hydrophobicity), it is also possible to apply lipophilization treatment to the surface of the magnetic material powder using a lipophilization agent. As the lipophilization agent, coupling agents and higher fatty acids are exemplified. The amount of the lipophilization agent added is preferably from 0.1 part by weight-10 parts by weight, more preferably 0.2 part by weight-6 parts by weight based on 100 parts by weight of the magnetic material powder.

Further, described is an image forming apparatus which can employ a two component developer composed of a toner containing the above composite resin particle containing a polyester resin and a styrene-acryl resin as well as a carrier, featuring the above shape factors SF-1 and SF-2, prepared by dispersing magnetic material powder in the binder resin. FIG. 2 is a schematic view showing one example of an image forming apparatus forming a toner image using the two component developer.

Symbols 1Y, 1M, 1C and 1K are photoreceptors, 4Y, 4M, 4C and 4K developing devices, 5Y, 5M, 5C and 5K primary transfer rollers as the primary transfer means, 5A a secondary transfer roller as the secondary transfer means, 6Y, 6M, 6C and 6K gleaning device, 7 an intermediate transfer unit, 24 a thermal roller fixing apparatus, and 70 an intermediate transfer material in FIG. 2.

This image forming apparatus is called a tandem color image forming apparatus, which is, as a main constitution, composed of plural image forming sections 10Y, 10M, 10C and 10B, an intermediate transfer material unit 7 as a transfer section including an endless belt form of a transfer belt, paper feeding and conveying means 22A to 22D to convey recording member P and heated roll-type fixing device 24 as a fixing means Original image reading device SC is disposed in the upper section of image forming apparatus body A.

Image forming section 10Y to form a yellow image as one of different color toner images formed on the respective photoreceptors comprises drum-form photoreceptor 1Y as the first photoreceptor; electrostatic-charging means 2Y, exposure means 3Y and developing means 4Y which are disposed around the photoreceptor 1Y; primary transfer roller 5Y as a primary transfer means; and cleaning means 6Y.

Image forming section 10M to form a magenta image as one of different color toner images formed on the respective photoreceptors comprises drum-form photoreceptor 1M as the second photoreceptor; electrostatic-charging means 2M, exposure means 3M and developing means 4M which are disposed around the photoreceptor 1M; primary transfer roller 5M as a primary transfer means; and cleaning means 6M.

Image forming section 10C to form a cyan image as one of different color toner images formed on the respective photoreceptors comprises drum-form photoreceptor 1C as the third photoreceptor; electrostatic-charging means 2Y, exposure means 3C and developing mean 4C which are disposed around the photoreceptor 1.C; primary transfer roller 5C as a primary transfer means; and cleaning means 6C.

Image forming section 10K to form a black image as one of different color toner images formed on the respective photoreceptors comprises drum-form photoreceptor 1K as the fourth photoreceptor; electrostatic-charging means 2K, exposure means 3K and developing means 4K which are disposed around the photoreceptor 1K; primary transfer roller 5K as a primary transfer means; and cleaning means 6K.

Intermediate transfer unit 7 of an endless belt form is turned by plural rollers has intermediate transfer material 70 as the second image carrier of an endless belt form, while being pivotably supported.

The individual color images formed in image forming sections 10Y, 10M, 10C and 10K are successively transferred onto the moving intermediate transfer material (70) of an endless belt form by primary transfer rollers 5Y, 5M, 5C and 5K, respectively, to form a composite color image. Recording member P of paper or the like, as a final transfer material housed in paper feed cassette 20, is fed by paper feed and conveyance means 21 and conveyed to secondary transfer roller 5A through plural intermediate rollers 22A, 22B, 22C and 22D and resist roller 23, and color images are transferred together on recording member P. The color image-transferred recording member (P) is fixed by heat-roll type fixing device 24, nipped by paper discharge roller 25 and put onto paper discharge tray 26 outside a machine.

After a color image is transferred onto recording member P by secondary transfer roller 5A, intermediate transfer material 70 which separated recording member P removes any residual toner by cleaning means 6A.

The primary transfer roller 5K is always compressed to the photoreceptor 1K. Other primary rollers 5Y, 5M and 5C are each the photoreceptors 1Y, 1M and 1C, respectively, only when forming color images.

Secondary transfer roller 5A is compressed onto intermediate transfer material 70 only when recording member P passes through to perform secondary transfer.

Housing 8 can be pulled out from the apparatus body (A) through supporting rails 82L and 82R.

The housing 8 is comprised of image forming sections 10Y, 10M, 10C and 10K and the intermediate transfer unit (7) of an endless belt form.

Image forming sections are arranged vertically in a line. Intermediate transfer material unit 7 of an endless belt form is disposed on the left side of photoreceptors 1Y, 1M, 1C and 1K, as indicated in FIG. 2. Intermediate transfer material unit 7 comprises the intermediate transfer unit (7) of an endless belt form which can be turned via rollers 71., 72, 73, 74 and 76, primary transfer rollers 5Y, 5M, 5C and 5K and cleaning means 6A.

The image forming sections 10Y, 10M, 10C and 10K and the intermediate transfer unit 7 are pulled out of the body A by pulling the housing 8.

In the process of image formation, toner images are formed on photoreceptors 1Y, 1M, 1C and 1K, through electrostatic-charging, exposure and development, toner images of the individual colors are superimposed on the endless belt form, intermediate transfer material (70), transferred together onto recording member P and fixed by compression and heating in heat-roll type fixing device 24.

After completion of transferring a toner image to recording member P, photoreceptors 1Y, 1M, 1C and 1K, any toner remained on which is cleaned by cleaning device 6Y, 6M, 6C and 6K, respectively, go into the foregoing cycle of electrostatic-charging, exposure and development to perform the subsequent image formation.

Further, a toner constituting the two component developer of the present invention is a so-called low-temperature fixing toner wherein a toner image is fixed at a lower temperature than those formed with conventional toners. Namely, when a transfer medium carrying a toner image which is formed with a toner constituting the two component developer of the present invention is treated using a heating roller of a surface temperature of 90° C.-150° C., stable fixing strength is exhibited wherein the toner tends not to peel off the transfer medium, even when forces such as creasing, bending, or rubbing are applied.

FIG. 3 is a schematic view showing one example of a fixing device employing a heating roller.

The fixing device 10 shown in FIG. 3 is provided with the heating roller 71 and the pressure roller 72 being adjacent thereto. Incidentally, in FIG. 5, the symbols 90 and 17 refer to a separating blade and a toner image formed on a transfer medium (transfer paper) P.

The heating roller 71, having a coating layer 82 formed of a fluorine resin or an elastomer lined around the surface of a cored bar 81, comprises a heating member 75 having a line heater.

The cored bar 81 containing metal features an inner diameter of 10-70 mm. The metal constituting the cored bar 81 is not specifically limited, including, for example, metal such as iron, aluminum, or copper, or alloys thereof.

The wall thickness of the cored bar 81 is from 0.1-15 mm, being determined in view of the balance between the demand of energy conservation (namely lessening the wall thickness) and its strength (depending on the constituent material). For example, in order to allow strength of an aluminum-cored bar to be the same as one of an iron-cored bar of 0.57 mm, the wall thickness of the former is needed to be 0.8 mm.

As the fluorine resin constituting the surface of the coating layer 82, polytetrafluoroethylene (PFE) and tetrafluoroethylene-perfluoroalkylvinylether copolymers (PFA) are exemplified.

The thickness of the coating layer 82 formed of the fluorine resin is from 10-500 μm, preferably 20-400 μm.

When the thickness of the coating layer 82 formed of the fluorine resin is less than 10 μm, the coating layer cannot function adequately, whereby it is impossible to ensure the durability of the fixing device. In contrast, the surface of the coating layer exceeding 500 μm is vulnerable to damage due to paper dust and then the toner tends to adhere to the damaged portion, resulting in occurrence of image contamination.

Further, as the elastomer constituting the coating layer 82, silicone rubber and silicone sponge rubber featuring excellent heat resistance such as LTV, RTV, or HVT are preferably used.

The ASKER-C hardness of the elastomer constituting the coating layer 32 is less than 80°, preferably less than 60°.

Further, the thickness of the coating layer 82 formed of the elastomer is preferably 0.1-30 mm, more preferably 0.1-20 mm.

As the heating member 75, a halogen heater is preferably used.

The pressure roller 72 has a coating layer 84 formed of an elastomer lined around the surface of a cored bar 83. The elastomer constituting the coating layer 84 is not specifically limited, including various soft rubbers such as urethane rubber or silicone rubber and sponge rubbers. A silicone rubber or a sponge rubber exemplified as one constituting the coating layer 84 is preferably used.

Further, the thickness of the coating layer 84 is preferably from 0.1-30 mm, more preferably from 0.1-20 mm.

Still further, the fixing temperature (the surface temperature of a heating roller 10) is preferably from 70-180° C., and the fixing line speed is preferably from 80-640 mm/sec. And the nip width of the heating roller is set at 8-40 mm, preferably 11-30 mm.

Incidentally, the separating blade 90 is arranged to prevent the transfer medium heat-fixed with the heating roller from winding itself around the heating roller.

An image formed employing the two component developer of the present invention is finally transferred to the transfer medium P and fixed on the transfer medium via fixing treatment. The transfer medium P is a support carrying a toner image and is commonly called an image support, a recording material, or transfer paper. Specifically, there are exemplified various transfer media including plain paper and bond paper being from thin to thick, coated printing paper such as art paper or coated paper, Japanese paper and postcard paper available on the market, OHP plastic films, and cloths; however being not limited thereto.

### EXAMPLES

The present invention will specifically be described with reference to the following examples that by no means limit the embodiments of the present invention.

1. Preparation of “Toners 1-3” and “Comparative Toner 1”

1-1. Preparation of “Composite Resin Particles 1-3”

(1) Preparation of “Composite Resin Particle 1”

A mixture of polymerizable monomers, described below, in a state heated at 95° C. was added in 240 parts by weight of water containing 2 parts by weight of dodecylbenzenesulfonic acid, followed by dispersing the mixture using an ultrasonic dispersing device to give oil droplets serving as a reaction liquid. Herein, the polymerizable monomers constituting the mixture are listed below.

| | |
|---|---|
| Azelaic acid | 32 parts by weight |
| 1,10-Decanediol | 28 parts by weight |
| Styrene | 80 parts by weight |
| Butyl acrylate | 20 parts by weight |

Subsequently, this reaction liquid was allowed to react at a temperature of 95° C. for 24 hours to form a polyester resin. Then, the temperature of the reaction system was decreased to 80° C., followed by addition of an aqueous solution containing 1.5 parts by weight of potassium persulfate to form a styrene-acryl resin via radical polymerization carried out for 5 hours. In this way, “composite resin particle 1” containing the polyester resin and the styrene-acryl resin was prepared.

The polyester resin component was isolated from “composite resin particle 1” and the molecular weight thereof was determined via gel-permeation chromatography (GPC). The weight average molecular weight (Mw) and the number average molecular weight (Mn) thereof were 20,000 and 10,000, respectively. Then, the glass transition point and the softening point thereof were 60° C. and 125° C., respectively.

Further, the styrene-acryl resin component was isolated from “composite resin particle 1” and the molecular weight thereof was determined. The weight average molecular weight (Mw), the number average molecular weight (Mn), and the molecular weight distribution (Mw/Mn) thereof were 52,000, 9,000, and 5.7, respectively. And the glass transition point and the softening point thereof were 53° C. and 118° C., respectively.

Further, the size of “composite resin particle 1” was 210 nm in terms of a number average primary particle diameter

(2) Preparation of “composite resin particle 2”

A mixture of polymerizable monomers, described below, in a state heated at 95° C. was added in 240 parts by weight of water containing 3 parts by weight of dodecylbenzenesulfonic acid, formed by dispersing the mixture using an ultrasonic dispersing device to give oil droplets serving as a reaction liquid. Herein, the polymerizable monomers constituting the mixture are listed below.

| | | |
|---|---|---|
| Polyoxyethylene (2,2)-2,2-bis(4- | 22 | parts by weight |
| hydroxyphenyl)propane | | |
| Neopentylglycol | 1.2 | parts by weight |
| Terephthalic acid | 10 | parts by weight |
| Isophthalic acid | 0.6 | part by weight |
| Styrene | 80 | parts by weight |
| 2-Ethylhexyl acrylate | 20 | parts by weight |

Subsequently, this reaction liquid was allowed to react at a temperature of 95° C. for 24 hours to form a polyester resin. Then, the temperature of the reaction system was decreased to 80° C., followed by addition of an aqueous solution containing 1.5 parts by weight of potassium persulfate to form a styrene-acryl resin via radical polymerization carried out for 5 hours. In this way, “composite resin particle 2” containing the polyester resin and the styrene-acryl resin was prepared.

The polyester resin component was isolated from “composite resin particle 2” and the molecular weight thereof was determined via gel-permeation chromatography (GPC). The weight average molecular weight (Mw) and the number average molecular weight (Mn) thereof were 30,000 and 9,000, respectively. And the glass transition point and the softening point thereof were 52° C. and 117° C., respectively.

Further, the styrene-acryl resin component was isolated from “composite resin particle 2” and the molecular weight thereof was determined. The weight average molecular weight (Mw), the number average molecular weight (Mn), and the molecular weight distribution (Mw/Mn) thereof were 53,000, 8,500, and 6.2, respectively. And the glass transition point and the softening point thereof were 51° C. and 114° C., respectively.

Further, the size of “composite resin particle 2” was 230 nm in terms of a number average primary particle diameter.

(3) Preparation of “Composite Resin Particle 3”

A mixture of polymerizable monomers, described below, in a state heated at 95° C. was added in 240 parts by weight of water containing 3 parts by weight of dodecylbenzenesulfonic acid, followed by dispersing the mixture using an ultrasonic dispersing device to give oil droplets serving as a reaction liquid. Herein, the polymerizable monomers constituting the mixture are listed below.

| | | |
|---|---|---|
| Polyoxyethylene(2,2)-2,2-bis(4- | 22 | parts by weight |
| hydroxyphenyl)propane | | |
| Neopentyl glycol | 1.2 | parts by weight |
| Terephthalic acid | 9.5 | parts by weight |
| Isophthalic acid | 0.5 | part by weight |
| Trimellitic acid | 0.5 | part by weight |
| Styrene | 80 | parts by weight |
| Butyl acrylate | 20 | parts by weight |

Subsequently, this reaction liquid was allowed to react at a temperature of 95° C. for 24 hours to form a polyester resin. Then, the temperature of the reaction system was decreased to 80° C., followed by addition of an aqueous solution containing 1.5 parts by weight of potassium persulfate to form a styrene-acryl resin via radical polymerization carried out for 5 hours. In this way, “composite resin particle 3” containing the polyester resin and the styrene-acryl resin was prepared.

The polyester resin component was isolated from “composite resin particle 3” and the molecular weight thereof was determined via gel-permeation chromatography (GPC). The weight average molecular weight (Mw) and the number average molecular weight (Mn) thereof were 50,000 and 5,000, respectively. And the glass transition point and the softening point thereof were 56° C. and 120° C., respectively.

Further, the styrene-acryl resin component was isolated from “composite resin particle 3” and the molecular weight thereof was determined. The weight average molecular weight (Mw), the number average molecular weight (Mn), and the molecular weight distribution (Mw/Mn) thereof were 53,000, 8,500, and 6.2, respectively. And the glass transition point and the softening point thereof were 52° C. and 117° C., respectively.

Further, the size of “composite resin particle 3” was 210 nm in terms of a number average primary particle diameter.

1-2. Preparation of “Colorant Dispersions 1-4”

(1) Preparation of “Colorant Dispersion 1”

In 30 parts of ion-exchanged water, 1.0 part by weight of sodium dodecylbenzenesulfonate was dissolved while stirring, and then 7 parts of carbon black “REGAL 330 R” (produced by Cabot Corp.) was gradually added in the resultant solution, followed by being dispersed using mechanical homogenizer “CLEARMIX” (produced by M Technique Co., Ltd.) to prepare “colorant dispersion 1.” The particle diameter of the colorant particles in “colorant dispersion 1” was determined to be 92 μm using electrophoretic light Electronics Co., Ltd.).

(2) Preparation of “Colorant Dispersion 2”

“Colorant dispersion 2” was prepared in the same manner as in preparation of “colorant dispersion 1” except that 8 parts by weight of a pigment “C.I. Pigment Yellow 185” was used instead of 7 parts by weight of the carbon black used in preparation of “colorant dispersion 1.” Herein, the particle diameter of the colorant particles in “colorant dispersion 2” was determined to be 87 nm using the electrophoretic light scattering spectrophotometer.

(3) Preparation of “Colorant Dispersion 3”

“Colorant dispersion 3” was prepared in the same manner as in preparation of “colorant dispersion 1” except that 8 parts by weight of a quinacridone magenta pigment “C.I. Pigment Red 122” was used instead of 7 parts by weight of the carbon black used in preparation of “colorant dispersion 1.” Herein, the particle diameter of the colorant particles in “colorant dispersion 3” was determined to be 90 nm using the electrophoretic light scattering spectrophotometer.

(4) Preparation of “Colorant Dispersion 4”

“Colorant dispersion 4” was prepared in the same manner as in preparation of “colorant dispersion 1” except that 7 parts by weight of a phthalocyanine cyan pigment “C.I Pigment Blue 15:3” was used instead of 7 parts by weight of the carbon black used in preparation of “colorant dispersion 1.” Herein, the particle diameter of the colorant particles in “colorant dispersion 4” was determined to be 90 nm using the electrophoretic light scattering spectrophotometer.

1-3. Preparation of “Wax Dispersions 1-3”

(1) Preparation of “Wax Dispersion 1”

In 30 parts by weight of ion-exchanged water, 1.0 part by weight of dodecylbenzenesulfonic acid, being an anion surfactant, was dissolved. The resultant solution was heated to 90° C. and 7 parts by weight of “carnauba wax (purified Carnauba wax No. 1)” having been heat-dissolved at 90° C. was gradually added therein while stirring. Subsequently, dispersion treatment was carried out at 90° C. for 7 hours using mechanical homogenizer “CLEARMIX” (produced by M Technique Co., Ltd.) to pro-pare “wax dispersion 1” via cooling at 30° C. Herein, the mass average particle diameter of the wax particles in “wax dispersion 1” was determined to be 95 nm using electrophoretic light scattering spectrophotometer “ELS-800” (produced by Otsuka Electronics Co., Ltd.).

(2) Preparation of “Wax Dispersion 2”

“Wax dispersion 2” was prepared in the same manner as in preparation of “wax dispersion 1” except that 7 parts by weight of “pentaerythritol behenate” serving as wax was used instead of “carnauba wax (purified Carnauba wax No. 1)” used in preparation of “wax dispersion 1.” Herein, the particle diameter of the wax particles in “wax dispersion 2” was determined to be 96 nm using the electrophoretic light scattering spectrophotometer.

(3) Preparation of “Wax Dispersion 3”

“Wax dispersion 3” was prepared in the same manner as in, preparation of “wax dispersion 1” except that 7 parts by weight of “Fischer-Tropsch wax” serving as wax was used instead of “carnauba wax (purified Carnauba wax No. 1)” used in preparation of “wax dispersion 1.” Herein, the mass average particle diameter of the wax particles in “wax dispersion 3” was determined to be 91 nm using the electrophoretic light scattering spectrophotometer.

1-4. Preparation of “Colored Particles 1K-3C”

(1) Preparation of “Colored Particle 1K”

A reaction container fitted with a stirrer, a thermometer, a reflux condenser, and a nitrogen suction pipe was charged with “composite resin particle 1”, 30 parts by weight of ion-exchanged water, “colorant dispersion 1”, and “wax dispersion 1”, followed by elevation of the interior temperature to 30° C. to prepare an aggregating dispersion. In this aggregating dispersion, a 5 mol/l sodium hydroxide aqueous solution was added to adjust pH at 10.0.

Subsequently, in the aggregating dispersion kept at 30° C., a solution prepared by dissolving 1 part by weight of magnesium chloride hexahydrate in 20 parts by weight of ion-exchanged water was added over 10 minutes while stirring. Then, the reaction system was allowed to stand for 1 minute, followed by elevation of the temperature to 90° C. over 10 minutes.

In this state, the particle diameter of aggregated particles was measured using “FPIA 2000”, and at the time when the number average particle diameter reached 5.2 μm, a solution prepared by dissolving 2 parts by weight of sodium chloride in 20 parts by weight of ion-exchanged water was added to the reaction system to terminate particle growth. Further, fusion was continued at 95° C. for 10 hours by heating/stirring for shape controlling. Thereafter, the system was cooled down to 30° C. and hydrochloric acid was added to adjust pH at 2.0, and then stirring was terminated.

The prepared colored particle was filtered and then washed repeatedly with ion-exchanged water of 45° C., followed by being hot-air dried at 40° C. to give “colored particle 1K.”

(2) Preparation of “Colored Particle 2K”

Particle growth was carried out in the same manner as in preparation of “colored particle 1K” except that “composite resin particle 2” and “wax dispersion 2” were used instead of “composite resin particle 1” and ” wax dispersion 1”, respectively, and also pH of the dispersion liquid mixture was adjusted at 11.0. Then, at the time when the number average particle diameter reached 5.5 μm, the particle growth was terminated to prepare “colored particle 2K” in the same manner as for “colored particle 1K.”

(3) Preparation of “Colored Particle 3K”

Particle growth was carried out in the same manner as in preparation of “colored particle 1K” except that “composite resin particle 3” and “wax dispersion 3” were used instead of “composite resin particle 1” and ” wax dispersion 1”, respectively, and also pH of the dispersion liquid mixture was adjusted at 10.5. Then, at the time when the number average particle diameter reached 5.5 μm, the particle growth was terminated to prepare “colored particle 3K” in the same manner as for “colored particle 1K.”

(4) Preparation of “Colored Particles 1Y, 1M, and 1C”

“Colored particle 1Y” was prepared in the same manner as in preparation of “colored particle 1K” except that “colorant dispersion 2” was used instead of “colorant dispersion 1” used in preparation of “colored particle 1K” and also particle growth was terminated at the time when the number average particle diameter reached 5.2 μm.

Further, “colored particle 1M” was prepared in the same manner as in preparation of “colored particle 1Y” except that “colorant dispersion 3” was used instead of “colorant dispersion 2” used in preparation of “colored particle 1Y”, and “Colored particle 1C” was then prepared in the same manner as in preparation of “colored particle 1Y” except that “colorant dispersion 4” was used instead of “colorant dispersion 2.”

(5) Preparation of “Colored Particles 2Y, 2M, and 2C”

“Colored particle 2Y” was prepared in the same manner as in preparation of “colored particle 2K” except that “colorant dispersion 2” was used instead of “colorant dispersion 1” used in preparation of “colored particle 2K”, and also pH of the dispersion liquid mixture was adjusted at 9.0 and also particle growth was terminated at the time when the number average particle diameter reached 5.5 μm.

Further, “colored particle 2M” was prepared in the same manner as in preparation of “colored particle 2Y” except that “colorant dispersion 3” was used instead of “colorant dispersion 2” used in preparation of “colored particle 2Y”, and “colored particle 2C” was then prepared in the same manner as in preparation of “colored particle 2Y” except that “colorant dispersion 4” was used instead of “colorant dispersion 2.”

(6) Preparation of “Colored Particles 3Y, 3M, and 3C”

“Colored particle 3Y” was prepared in the same manner as in preparation of “colored particle 3B” except that “colorant dispersion 2” was used instead of “colorant dispersion 1” used in preparation of “colored particle 3K”, and particle growth was terminated at the time when the number average particle diameter reached 5.5 μm.

Further, “colored particle 3M” was prepared in the same manner as in preparation of “colored particle 3Y” except that “colorant dispersion 3” was used instead of “colorant dispersion 2” used in preparation of “colored particle 3Y”, and “colored particle 3C” was then prepared in the same manner as in preparation of “colored particle 3Y” except that “colorant dispersion 4” was used instead of “colorant dispersion 2.”

1-5. Preparation of “Toners 1K-3C”

To 100 parts by weight of each of “colored particles 1K-3C”, 1.0 part by weight of silica featuring a number average primary particle diameter of 12 nm and a degree of hydrophobization of 80 as well as 1.0 part by weight of titania featuring a number average primary particle diameter of 25 nm and a degree of hydrophobization of 80 were added, followed by mixing using a Henschel mixer to prepare each of “Toners 1K-3C.” Incidentally, the shape and the particle diameter of these toners did not vary even via addition of an external additive.

1-6. Preparation of “Comparative Toners 1K-1C”

(1) Preparation of “Comparative Toner 1K”

Into a reaction container fitted with a stirrer, a thermometer, a reflux condenser, and a nitrogen suction pipe, the following substances were placed and then the reaction system was heated under a nitrogen gas ambience.

| | |
|---|---|
| Terephthalic acid | 299 parts by weight |
| Polyoxypropylene(2,2)-2,2-bis(4- | 211 parts by weight |
| hydroxyphenyl)propane | |
| Pentaerythritol | 82 parts by weight |

Further, 0.05 part by weight of dibutyltin oxide was added to the reaction system, followed by carrying out polycondensation at a temperature of 200° C. to prepare “polyester resin A.” The glass transition point and the softening point of “polyester resin A” were 59° C. and 131° C., respectively.

Then, components described below were mixed and the mixed components were melted, kneaded, cooled, pulverized, and classified to prepare “comparative colored particle 1K” of a 6.8 μm volume based median diameter.

| | |
|---|---|
| Polyester resin A | 100 parts by weight |
| Styrene-acryl resin | 90 parts by weight |
| Carbon black | 6 parts by weight |
| Pentaerythritol behenate | 6 parts by weight |

Incidentally, the styrene-acryl resin was prepared so that the weight ratio of the styrene-derived component to the butyl acrylate-derived component was 72:28. The glass transition point and the softening point of the resin were 53° C. and 121° C., respectively.

To thus-prepared “comparative colored particle 1K”, 1.0 part by weight of silica featuring a number average primary particle diameter of 12 nm and a degree of hydrophobization of 80 as well as 1.0 part by weight of titania featuring a number average primary particle diameter of 25 nm and a degree of hydrophobization of 80 were mixed, followed by addition using a Henschel mixer to prepare “Comparative Toner 1K.”

(2) Preparation of “Comparative Toners 1Y, 1M, and 1C”

“Comparative colored particle 1Y” of a 6.8 μm volume based median diameter was obtained in the same manner as in preparation of “comparative colored particle 1K” except that 8 parts by weight of a pigment “C.I. Pigment Yellow 185” was used instead of the carbon black used in preparation of “Comparative Toner 1K.” Then, “Comparative Toner 1Y” was prepared in the same manner as for “Comparative Toner 1K.”

Further, “comparative colored particle 1M” of a, 6.8 μm volume based median diameter was obtained in the same manner as in preparation of “comparative colored particle 1K” except that 9 parts by weight of a quinacridone magenta pigment “C.I. Pigment Red 122” was used instead of the carbon black used in preparation of “Comparative Toner 1K.” Then, “comparative colored particle 1C” of a 6.8 μm volume based median diameter was obtained in the same manner as in preparation of “comparative colored particle 1K” except that 9 parts by weight of a phthalocyanine cyan pigment “C.I. Pigment Blue 15:3” was used instead of the carbon black used in preparation of “Comparative Toner 1K.” Both “comparative colored particle 1M” and “comparative colored particle 1C” were subjected to external additive treatment in the same manner as for “Comparative Toner 1K” to prepare “Comparative Toner 1M” and “Comparative Toner 1C”, respectively.

The resins used and the preparation method-s employed for “Toners 1-3” and “Comparative Toner 1” as well as the volume based median diameters (D50's) of the prepared toners are listed in Table 1.

TABLE 1

| | | | Volume |
|---|---|---|---|
| | | | Based |
| | Toner | | Median |
| Toner | | Preparation | Diameter |
| No. | Resin Used | Method | (μm) |
| 1 | Composite resin Particle 1 | Polymerization | 5.2 |
| | | Method | |
| 2 | Composite resin Particle 2 | Polymerization | 5.5 |
| | | Method | |
| 3 | Composite resin Particle 3 | Polymerization | 5.5 |
| | | Method | |
| 4 | Polyester Resin + Styrene- | Pulverization | 6.8 |
| | acryl Resin | Method | |

2. Preparation of “Carriers 1-5” and “Comparative Carriers 1-4”

(1) Preparation of “Carrier 1”

Magnetite powder (FeO.Fe₂O₃) of a 0.24 μm number average primary particle diameter and α-Fe₂O₃ powder of a 0.60 μm number average primary particle diameter were placed into two individual containers fitted with a stirrer, followed by addition of a silane coupling agent “3-(2-aminoethylaminopropyl)dimethoxysilane” into each of the containers. The amount of the silane-coupling agent added was determined so as to allow the ratio of the silane-coupling agent to be 5.5% by weight.

Subsequently, each of the containers fitted with a stirrer was heated to 100° C., followed by mixing and agitating the input substances at a high speed to prepare “lipophilized magnetite powder A” and “lipophilized α-ferric oxide powder A.”

Further, “composition (1)” composed of the components described below was added in an aqueous medium containing 28% by weight NH₄OH solution. Herein, the constitution of “composition (1)” was as shown below.

| | |
|---|---|
| Lipophilized magnetite powder A | 60 parts by weight |
| Lipophilized α-ferric oxide powder A | 40 parts by weight |
| Phenol | 10 parts by weight |
| Formaldehyde solution (formaldehyde: 40% by | 6 parts by weight |
| weight; methanol: 10% by weight; and pure water: | |
| 50% by weight) | |

“Composition (1)” was added in the aqueous medium, and then the resultant mixture was mixed/stirred at 10,000 rotations/min (rpm) for 5 minutes using T. K. Homo Mixer. Thereafter, the mixture was heated to 85° C. over 40 minutes while mixing/stirring at a condition of 120 rpm, followed by thermalcuring reaction for 3 hours as this temperature was kept. Subsequently, the resultant product was cooled down to 30° C. and water was added thereto. Thereafter, the supernatant liquid was removed, and then the precipitates were washed, followed by being air-dried. Further, drying treatment was carried out at 60° C. under a pressure of at most 665 Pa to prepare “carrier particle a.”

Subsequently, a coating solution containing 10% by weight of a silicone resin material known ill the art was prepared (toluene was used as the solvent). The solvent was evaporated from this coating solution via continuous shear stress and the surface of “carrier particle a”, being a core particle, was coated with the thus-treated coating solution so as to allow the coated resin amount to be 1.0% by weighty Then, curing treatment was carried out at 200° C. for 1 hour, followed by pulverization treatment and then classification treatment with a 200-mesh sieve. In this way, a resin dispersion-type “Carrier 1” coated with the silicone resin was prepared wherein a phenol-formaldehyde resin was employed for the binder resin.

The volume based median diameter of “Carrier 1” was 34 μm and the shape factors SF-1 and SF-2 thereof were 1.05 and 1.51, respectively. Further, the magnetization force thereof was 129 emu/cm³ at 1 k oersted.

Herein, the volume based median diameter of the carrier was determined using laser diffraction system particle size distribution meter provided with a wet type homogenizer “HELOS” (produced by SYMPATEC Co.). Further, the shape factors SF-1 and SF-2 were determined by analyzing carrier particles, photographed with field emission scanning electron microscope “S-4500” (produced by Hitachi, Ltd.), employing image analyzer “LUZEX 3” (produced by Nireco Corp.). Then, the magnetization force was determined employing vibration magnetic field-type magnetic property automatic recorder “BHV-30” (produced by Riken Denshi Co., Ltd.)

(2) Preparation of “Carrier 2”

“Carrier 2” was prepared in the same manner as in preparation of “Carrier 1” except that the stirring condition and the reaction temperature for “Carrier 1” were changed to 80 rpm and 95° C., respectively. The volume based median diameter of “Carrier 2” was 34 μm, and the shape factors SF-1 and SF-2 thereof were 1.02 and 1.12, respectively. Further, the magnetization force thereof was 129 emu/cm³ at 1 kilooersted.

(3) Preparation of “Carrier 3”

“Carrier 3” was prepared in the same manner as in preparation of “Carrier 1” except that the stirring condition and the reaction temperature for “Carrier 1” were changed to 150 rpm and 95° C., respectively. The volume based median diameter of “Carrier 3” was 34 μm, and the shape factors SF-1 and SF-2 thereof were 1.19 and 2.48, respectively. Further, the magnetization force thereof was 129 emu/cm³ at 1 kilooersted.

(4) Preparation of “Carrier 4”

“Carrier 4” was prepared in the same manner as in preparation of “Carrier 1” except that the stirring condition of T. K. Homo Mixer for “Carrier 1” was changed to 13,000 rotations/min. The volume based median diameter of “Carrier 4” was 12 μm, and the shape factors SF-1 and SF-2 thereof were 1.05 and 1.51, respectively. Further, the magnetization force thereof was 129 emu/cm³ at 1 kilooersted.

(5) Preparation of “Carrier 5”

“Carrier 5” was prepared in the same manner as in preparation of “Carrier 1” except that the stirring condition of T. K. Homo Mixer for “Carrier 1” was changed to 3,000 rotations/min. The volume based median diameter of “Carrier 5” was 95 μm, and the shape factors SF-1 and SF-2 thereof were 1.05 and 1.51, respectively. Further, the magnetization force thereof was 129 emu/cm³ at 1 kilooersted.

(6) Preparation of “Comparative Carrier 1”

“Comparative Carrier 1” was prepared in the same manner as in preparation of “Carrier 1” except that the stirring condition and the reaction temperature for “Carrier 1” were changed to 250 rpm and 98° C., respectively. The volume based median diameter of “Comparative Carrier 1” was 35 μm, and the shape factors, SF-1 and SF-2 thereof were 1.23 and 2.65, respectively. Further, the magnetization force thereof was 129 emu/cm³ at 1 kilooersted.

(7) Preparation of “Comparative Carrier 2”

“Comparative Carrier 2” was prepared in the same manner as in preparation of “Carrier 1” except that the stirring condition, the reaction temperature, and the reaction duration for “Carrier 1” were changed to 50 rpm, 70° C., and 6 hours, respectively. The volume based median diameter of “Comparative Carrier 2” was 35 μm, and the shape factors SF-1 and SF-2 thereof were 0.98 and 1.03, respectively. Further, the magnetization force thereof was 129 emu/cm³ at 1 kilooersted.

(8) Preparation of “Comparative Carrier 3”

By classifying the carrier particles formed in preparation of “Carrier 4”, prepared was “Comparative Carrier 3” featuring a volume based median diameter of 9 μm and shape factors SF-1 and SF-2 of 1.05 and 1.51, respectively, as well as a magnetization force of 129 emu/cm³ at 1 kilooersted.

(9) Preparation of “Comparative Carrier 4”

By classifying the carrier particles formed in preparation of “Carrier 5”, prepared was “Comparative Carrier 4”, featuring a volume based median diameter of 105 μm and shape factors SF-1 and SF-2 of 1.05 and 1.51, respectively, as well as a magnetization force of 129 emu/cm at 1 kilooersted.

The volume based median diameters (D50's) and the shape factors SF-1's and SF-2's of “Carriers 1-5” and “Comparative Carriers 1-4” described above are listed in Table 2 as shown below.

TABLE 2

| | |
|---|---|
| Volume Based | |
| Median | Shape Factor |

| Carrier No. | Diameter (μm) | SF-1 | SF-2 |
|---|---|---|---|
| 1 | 34 | 1.05 | 1.51 |
| 2 | 34 | 1.02 | 1.12 |
| 3 | 34 | 1.19 | 2.48 |
| 4 | 12 | 1.05 | 1.51 |
| 5 | 95 | 1.05 | 1.51 |
| Comparative 1 | 35 | 1.23 | 2.65 |
| Comparative 2 | 35 | 0.98 | 1.03 |
| Comparative 3 | 9 | 1.05 | 1.51 |
| Comparative 4 | 105 | 1.05 | 1.51 |

3. Preparation of “Developers 1-13”

“Developers 1-13”, combined as listed in Table 3, were prepared in combinations of 20 parts by weight of a given one selected from “Toners 1K-3C” and “Comparative Toners 1K-1C” and 400 parts by weight of a given one selected from “Carriers 1 5” and “Comparative Carriers 1-4.” Then, “Developers 1-7” and “Developers 8-13” were designated as “Examples 1-7” and “Comparative Examples 1-6”, respectively.

4. Evaluation Experiments

(1) Evaluating Equipment

Evaluations were carried out with A4-size bond paper (64 g/m²) employing two component development-system multifunction peripheral “Bizhub Pro C500” (produced by Konica Minolta Business Technologies, Inc.) featuring the constitution shown in FIG. 2 under a high-temperature and humidity ambience (temperature: 33° C.; and humidity: 85% RH). Image formation was conducted onto 100,000 sheets of the paper in a one-sheet intermittent mode, wherein a full-color image having a 56 pixel ratio of each of yellow (Y)/magenta (M)/cyan (C)/black (K) was printed. Herein, this experimental mode refers to an environment where low-melting components in the toner Lend to fuse due to a high temperature in the surrounding environment.

(2) Evaluation Items

Evaluations were conducted on charging amount, image density (reflection density of a solid black portion), fog density (reflection density of a white portion), and presence or absence of toner flies at the initial stage and at the stage after completion of 100,000-sheet printing.

(Charging Amount)

A charging amount of the toner was evaluated at the initial stage and at the stage after completion of 100,000-sheet printing. The charging amount was measured using blow-off charging amount measuring apparatus “TB-200” (produced by Toshiba Chemical Corp.) in the following steps.

A two component developer to be measured was placed on the charging amount measuring apparatus equipped with a 400-mesh stainless steel screen, followed by blowing with nitrogen gas at a 50 kPa blow pressure condition for 10 seconds to measure the charge. The charging amount (−μC/g) was calculated by dividing the measured charge by the mass of the flown toner.

(Image Density)

Densities of solid black images printed at the initial stage and at the stage after completion of 100,000-sheet printing were evaluated. Specifically, reflection densities at randomly selected, 5 locations on a sheet of paper (white paper) with no image printed thereon were measured and the average value was designated as the white paper density. Then, image densities at randomly selected 5 locations on a solid black image portion were measured and the average value was designated as the average reflection density. A value obtained by subtracting the white paper density from the average reflection density was designated as the reflection density. The measurements were carried out using reflective densitometer “RD-918” (Gretag Macbeth A G.)

(Fog Density)

White densities were evaluated at the initial stage and at the stage after completion of 100,000-sheet printing. Specifically, reflection densities at randomly selected 5 locations on a sheet of paper (white paper) with no image printed thereon were measured and the average value was designated as the white paper density. Then, reflection densities at randomly selected 5 locations on a non-image portion of the final image were measured and the average value was designated as the average reflection density. A value obtained by subtracting the white paper density from the average reflection, density was designated as the fog density. The measurements were carried out using reflective densitometer “RD-918” (Gretag Macbeth A G.).

(Toner Flies)

At the stage after completion of 100,000-sheet printing, evaluations were visually carried out on a state in terms of whether or not the toner spilled around the developing device and also contamination in the apparatus due to toner flies occurred. “A” and “B” were ranked as “acceptable” based on the following criteria.

A: No contamination in the apparatus due to toner spills or toner flies was observed.

B: Slight contamination in the apparatus due to a small amount of toner spills or toner flies was observed, which indicates no practically problematic level (no occurrence of image defects)

C: Contamination in the apparatus due to toner spills or toner flies was observed, which indicates the practically problematic level due to occurrence of image defects due to the toner flies.

The results are listed in Table 3.

TABLE 3

| | | | | | | | | | | Toner |
|---|---|---|---|---|---|---|---|---|---|---|
| | | | | | | | | | | Flies |
| | | | | Charging | | Image | | | | after |
| | | | | Amount | | Density | | Fog Density | | 100,000- |
| | Developer No. | Toner No. | Carrier No. | *1 | *2 | *1 | *2 | *1 | *2 | sheet Printing |
| Example 1 | 1 | 1Y/1M/1C/1K | Carrier 1 | 21.2 | 20.6 | 1.41 | 1.41 | 0.000 | 0.001 | A |
| Example 2 | 2 | 1Y/1M/1C/1K | Carrier 2 | 21.3 | 18.9 | 1.41 | 1.40 | 0.000 | 0.001 | A |
| Example 3 | 3 | 1Y/1M/1C/1K | Carrier 3 | 20.3 | 17.6 | 1.41 | 1.40 | 0.000 | 0.001 | A |
| Example 4 | 4 | 1Y/1M/1C/1K | Carrier 4 | 22.3 | 21.2 | 1.41 | 1.40 | 0.000 | 0.001 | A |
| Example 5 | 5 | 1Y/1M/1C/1K | Carrier 5 | 18.9 | 17.6 | 1.41 | 1.42 | 0.000 | 0.001 | A |
| Example 6 | 6 | 2Y/2M/2C/2K | Carrier 1 | 21.3 | 20.5 | 1.41 | 1.41 | 0.000 | 0.001 | A |
| Example 7 | 7 | 3Y/3M/3C/3K | Carrier 1 | 21.9 | 20.5 | 1.41 | 1.41 | 0.000 | 0.001 | A |
| Comp. 1 | 8 | 1Y/1M/1C/1K | Comparative | 19.9 | 13.9 | 1.42 | 1.32 | 0.001 | 0.012 | C |
| | | | Carrier 1 | | | | | | | |
| Comp. 2 | 9 | 1Y/1M/1C/1K | Comparative | 23.8 | 27.9 | 1.39 | 1.24 | 0.000 | 0.003 | B |
| | | | Carrier 2 | | | | | | | |
| Comp. 3 | 10 | 1Y/1M/1C/1K | Comparative | 29.7 | 27.5 | 1.28 | 1.21 | 0.000 | 0.004 | B |
| | | | Carrier 3 | | | | | | | |
| Comp. 4 | 11 | 1Y/1M/1C/1K | Comparative | 15.6 | 11.3 | 1.45 | 1.26 | 0.001 | 0.015 | C |
| | | | Carrier 4 | | | | | | | |
| Comp. 5 | 12 | 4Y/4M/4C/4K | Carrier 1 | 21.2 | 14.8 | 1.41 | 1.27 | 0.000 | 0.011 | C |
| Comp. 6 | 13 | 4Y/4M/4C/4K | Comparative | 19.5 | 10.2 | 1.43 | 1.24 | 0.002 | 0.021 | C |
| | | | Carrier 1 | | | | | | | |

*1: At the Initial Stage,
*2: After 100,000-sheet Printing
Comp.: Comparative Example

As shown in table 3, in Examples 1-7, virtually no stage after completion of 100,000-sheet printing and also virtually no variation of the image density as well as the fog density was observed, whereby stable image formation was confirmed. Further, the results confirmed that no toner spills or toner flies were observed even at the stage after completion of 100,000-sheet printing, resulting in no occurrence of contamination in the apparatus. In contrast, in Comparative Examples 1-6, the results confirmed that variations in charging amount, image density, and fog density were observed between at the initial stage and at the stage after completion of 100,000-sheet printing, resulting in unstable image formation.

1. A two component developer comprising a toner containing at least a resin and a colorant, and a carrier, wherein
the resin is composed of a polyester resin and a styrene-acryl resins in which the polyester resin is prepared via condensation-polymerization of a polyvalent carboxylic acid and a polyol in a state where a styrene monomer and an acrylate monomer exist in an aqueous medium containing an acidic compound, followed by formation of the styrene-acryl resin via radical polymerization of the styrene monomer and the acrylate monomer; and
the carrier comprises magnetic material powder dispersed in a binder resin, and has a volume based median diameter of 10 μm-100 μm, a shape factor SF-1 of 1.0-1.2, and a shape factor SF-2 of 1.1-2.5,
wherein
SF-1={(maximum particle size of carrier particle)²/(projected area of carrier)}×(π/4)
and
SF-2={(circumference length of carrier particle)²/(projected area of carrier)}×(π/4).

2. The two component developer of claim 1, wherein
the toner is prepared by forming composite resin particles containing the polyester resin and the styrene-acryl copolymer resin, and coagulating the composite resin particles in an aqueous medium, wherein the composite resin particles are prepared by a method comprising steps of;
(i) forming oil droplets dispersed in an aqueous medium comprising a surfactant having a long chain hydrocarbon group and an acid group, the oil droplets comprising a poly condensable monomers including polycarboxylic acid having two or more carboxyl groups, a polyalcohol having two or more hydroxyl groups, and a radically polymerizable monomers including a styrene compound and an acrylate ester or methacrylate ester compound;
(ii) polycondensing the polycarboxylic acid and the polyalcohol to form the polyester resin in the oil droplets; and
(iii) radically polymerizing the styrene compound and the acrylate ester or the methacrylate ester compound to form a styrene-acryl copolymer resin in the oil droplets.

3. The two component developer of claim 2, wherein a number average primary particle diameter of the oil droplets is 50-500 nm.

4. The two component developer of claim 2, wherein colorant particles are coagulated in the step of coagulating.

5. The two component developer of claim 2, wherein the long chain hydrocarbon group of the surfactant having a long chain hydrocarbon group and an acid group is an aromatic hydrocarbon group which may contain an alkyl group having a carbon number of 8-40.

6. The two component developer if claim 5, wherein the long chain hydrocarbon group is a phenyl group having an alkyl group having a carbon number of 8-30.

7. The two component developer of claim 2, wherein the acid group of the surfactant having a long chain hydrocarbon group and an acid group is a sulfonic acid group.

8. The two component developer of claim 2, wherein a content of the surfactant having a long chain hydrocarbon group and an acid group is not less than the critical micelle concentration in the aqueous medium.

9. The two component developer of claim 2, wherein a content of the surfactant having a long chain hydrocarbon group and an acid group is 0.01-2% by weight based on the weight of the aqueous medium.

10. The two component developer of claim 2, wherein a content of polycondensable monomer is 10-90% by weight based on the weight of the whole composition forming composite resin particles.

11. The two component developer of claim 10, wherein content of polycondensable monomer is 20-80% by weight based on the weight of the whole composition forming composite resin particles.

12. The two component developer of claim 2, wherein a weight average molecular weight (Mw) of the polyester resin is not less than 10,000.

13. The two component developer of claim 2, wherein a number average molecular weight (Mn) of the polyester resin is at most 20,000.

14. The two component developer of claim 2, wherein a weight average molecular weight (Mw) of the styrene-(meth)acrylate resin is 2,000-1,000,000.

15. The two component developer of claim 2, wherein a number average molecular weight (Mn) of the styrene-(meth)acrylate resin is 1,000-100,000.

16. The two component developer of claim 2, wherein the magnetic material powder in the carrier particles is a magnetite or a ferrite.

17. The two component developer of claim 2, wherein a number average primary particle diameter of the magnetic material powder is 0.1 μm-0.5 μm.

18. The two component developer of claim 2, wherein a content of magnetic material powder in the carrier is 40%-99% by weight.

19. The two component developer of claim 2, wherein the polyalcohol is neopentylglycol, or bisphenol A.

20. A two component developer comprising a toner containing at least a resin and a colorant, and a carrier, wherein
the resin is composed of a polyester resin and a styrene-acryl resin, and the toner is obtained by agglomerating composite particles having the resin, and
the carrier comprises magnetic material powder dispersed in a phenol-formaldehyde resin, wherein the magnetic powder is dispersed via preparation of the phenol-formaldehyde resin, and the carrier has a volume based median diameter of 10 μm-100 μm, a shape factor SF-1 of 1.0-1.2, and a shape factor SF-2 of 1.1 2.5, wherein
SF-1={(maximum particle size of carrier particle)²/(projected area of carrier))×(π/4)
and
SF-2={(circumference length of carrier particle)²/(projected area of carrier)×(π/4).
